(19) United States
(12) Patent Application Publication
(10) Pub. No.: US 2026/0280784 A1
(43) Pub. Date: Sep. 17, 2026

(54) PACKET CONCATENATION CONFIGURATION

(71) Applicant: QUALCOMM Incorporated, San Diego, CA (US)

(72) Inventors: Sherif ELAZZOUNI, San Diego, CA (US); Prashanth Haridas HANDE, San Diego, CA (US); Gavin Bernard HORN, La Jolla, CA (US); Ozcan OZTURK, San Diego, CA (US)

(21) Appl. No.: 19/078,712

(22) Filed: Mar. 13, 2025

(51) Int. Cl. H04L 5/00; H04L 69/22; H04W 72/1273

(52) U.S. Cl. CPC H04L 5/0044; H04L 5/0048; H04L 69/22; H04W 72/1273

(57) ABSTRACT

Certain aspects of the present disclosure provide techniques for packet concatenation configuration. An example method includes sending, to a second network node, one or more configurations that include an indication of one or more parameters associated with data frame segmentation at a first protocol stack layer; and sending, to the second network node, a data frame that includes a concatenation of a plurality of packets, wherein the data frame is associated with a second protocol stack layer and addressed to a user equipment in communication with the second network node via a wireless communication link.

### FIELD OF THE DISCLOSURE

Aspects of the present disclosure relate to wireless communications, and more particularly, to techniques for wireless communications through a protocol stack.

### DESCRIPTION OF RELATED ART

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

Certain aspects provide a method for wireless communications by a first network node. The method includes sending, to a second network node, one or more configurations that include an indication of one or more parameters associated with data frame segmentation at a first protocol stack layer; and sending, to the second network node, a data frame that includes a concatenation of a plurality of packets, wherein the data frame is associated with a second protocol stack layer and addressed to a user equipment in communication with the second network node via a wireless communication link.

Certain aspects provide a method for wireless communications by a first network node. The method includes obtaining, from a second network node, one or more configurations that include an indication of one or more parameters associated with data frame segmentation at a first protocol stack layer; obtaining, from the second network node, a data frame that includes a concatenation of a plurality of packets, wherein the data frame is associated with a second protocol stack layer and addressed to a user equipment in communication with the first network node via a wireless communication link; and sending, to the user equipment, signaling that includes at least a portion of the data frame.

Other aspects provide: one or more apparatuses operable, configured, or otherwise adapted to perform any portion of any method described herein (e.g., such that performance may be by only one apparatus or in a distributed fashion across multiple apparatuses); one or more non-transitory, computer-readable media comprising instructions that, when executed by one or more processors of one or more apparatuses, cause the one or more apparatuses to perform any portion of any method described herein (e.g., such that instructions may be included in only one computer-readable medium or in a distributed fashion across multiple computer-readable media, such that instructions may be executed by only one processor or by multiple processors in a distributed fashion, such that each apparatus of the one or more apparatuses may include one processor or multiple processors, and/or such that performance may be by only one apparatus or in a distributed fashion across multiple apparatuses); one or more computer program products embodied on one or more computer-readable storage media comprising code for performing any portion of any method described herein (e.g., such that code may be stored in only one computer-readable medium or across computer-readable media in a distributed fashion); and/or one or more apparatuses comprising one or more means for performing any portion of any method described herein (e.g., such that performance would be by only one apparatus or by multiple apparatuses in a distributed fashion). By way of example, an apparatus may comprise a processing system, a device with a processing system, or processing systems cooperating over one or more networks. An apparatus may comprise one or more memories; and one or more processors configured to cause the apparatus to perform any portion of any method described herein. In some examples, one or more of the processors may be preconfigured to perform various functions or operations described herein without requiring configuration by software.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of network entities and a user equipment (UE).

FIGS. 4A, 4B, 4C, and 4D depict various example aspects of data structures for a wireless communications network.

FIG. 5A depicts an example control plane protocol stack.

FIG. 5B depicts an example user plane protocol stack.

FIG. 6 depicts an example scheme for downlink data flow of a concatenated packet through a disaggregated base station architecture.

FIG. 7 depicts a process flow for communication of protocol stack concatenation configuration.

FIG. 8 depicts a process flow for communication of feedback associated with packet concatenation.

FIG. 9 depicts a process flow for enquiry-response per packet in association with packet concatenation.

FIG. 10 depicts a method for wireless communications.

FIG. 11 depicts another method for wireless communications.

FIG. 12 depicts aspects of an example communications device.

### DETAILED DESCRIPTION

Aspects of the present disclosure provide apparatuses, methods, processing systems, and computer-readable mediums for packet concatenation configuration for a radio access network (RAN), such as a disaggregated RAN.

As used herein, a concatenated packet may refer to a packet or data frame (e.g., a unit of data or information) that includes a payload of concatenated packets or a concatenation of packets. A service data unit (SDU) may refer to a unit of data or information (e.g., a packet) that has been obtained at a given layer of a protocol stack (for example, from an upper layer); and a packet data unit (PDU) may refer to a unit of data or information (e.g., a packet) that encapsulates at least one SDU, at the given layer, for example, that will be provided to a lower layer of the given layer or a receiving device. Thus, the SDU and PDU are generally forms of a packet in a given layer of a protocol stack, where the SDU is a packet that is included in the payload of the PDU.

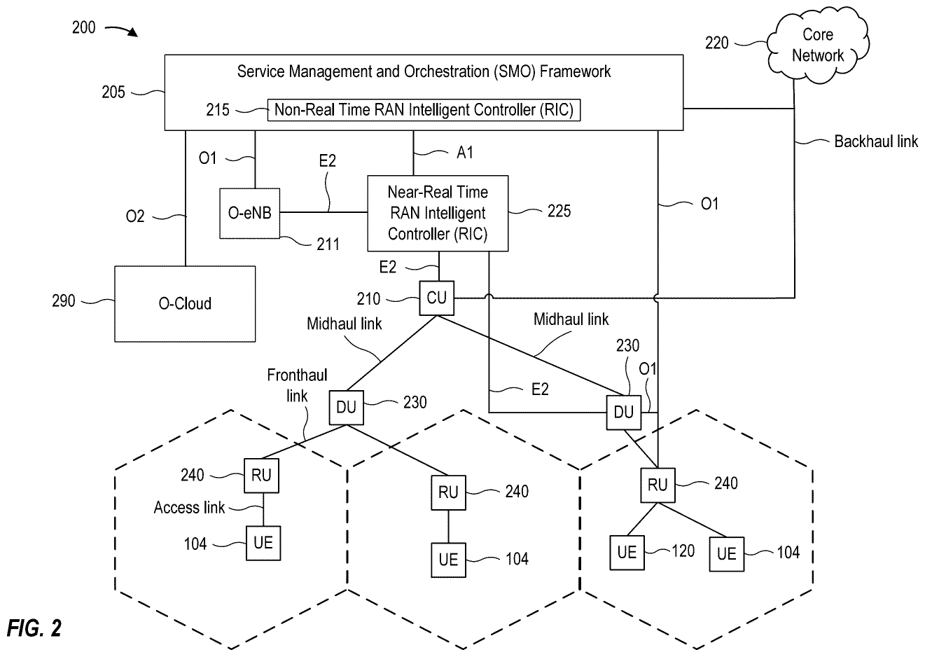

A wireless communication system (e.g., a 5G New Radio (NR) system and/or any other suitable or future system) may employ a disaggregated RAN architecture (for example, as further described herein with respect to FIG. 2) to enable wireless communications between a user equipment (UE) and the RAN. Reference to a RAN performing certain operations, as discussed herein, may refer to one or more network nodes (e.g., a base station and/or one or more disaggregated entities thereof) performing said operations. In certain cases, the disaggregated RAN architecture may be or include a virtualized or cloud-based RAN. The disaggregated RAN architecture may refer to a RAN that includes a base station that is split (e.g., functionally split) into multiple network nodes (which may be virtualized or physical entities). As an example, the disaggregated RAN architecture may include a central unit (CU), a distributed unit (DU), and in some cases, a radio unit (RU). The CU may control one or more DUs, and each DU may control one or more RUs. The RU may enable a radio access link between the UE and the RAN and perform certain low-level physical layer functions, such as digital signal processing and/or analogue processing including reception of radio frequency (RF) signaling, and/or transmission of RF signaling.

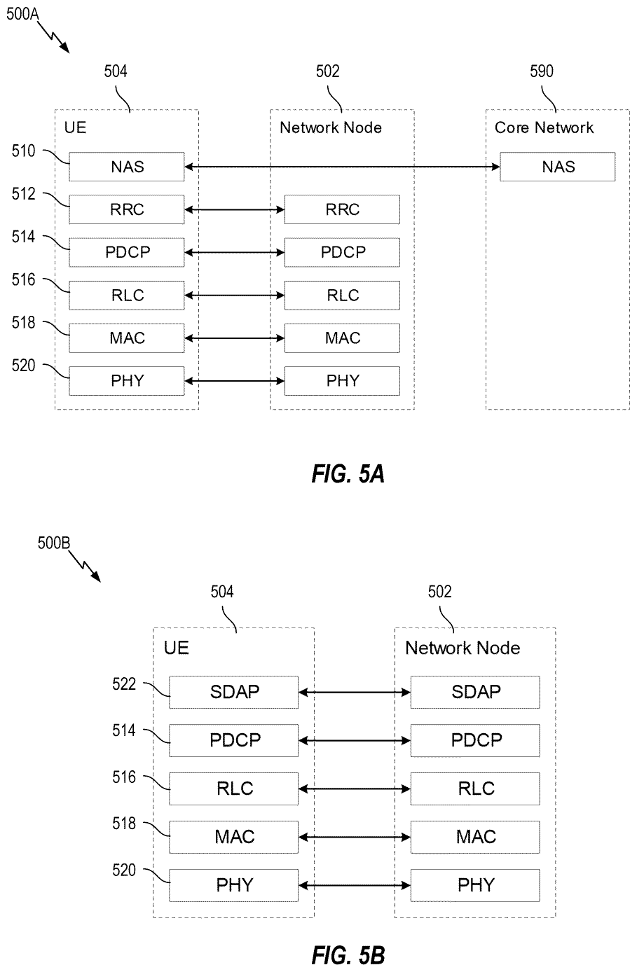

In certain cases, the wireless communication system may use protocol stack(s) to transfer information between a UE and a RAN and/or between a UE and an application server, for example, as further described herein with respect to FIGS. 5A and 5B. A protocol stack may specify certain communication protocols for transferring information between the UE and the RAN and/or between the UE and an application server. The protocol stack may be arranged with multiple functional layers. As an example, a user plane protocol stack may include a service data adaptation protocol (SDAP) layer, a packet data convergence protocol (PDCP) layer, a radio link control (RLC) layer, a medium access control (MAC) layer, and a physical (PHY) layer, each of which is further described herein with respect to FIGS. 5A and 5B.

In certain cases, the protocol stack may be split among the network nodes of a disaggregated RAN (e.g., a RAN having one or more base stations with a disaggregated architecture). As an example, the CU may be responsible for performing operations at the SDAP layer and/or PDCP layer; and the DU may be responsible for performing operations at the RLC layer, MAC layer, and/or PHY layer. In certain cases, the RU may be responsible for performing operations at the PHY layer and/or certain operations of the MAC layer, such as MAC-based retransmissions.

Technical problems for wireless communications may include, for example, effective communication of information through a protocol stack in a disaggregated RAN architecture. As part of certain packet encapsulation operations related to the protocol stack, multiple packet headers and/or integrity protection bits may be added to a packet at certain layers of the protocol stack. In certain cases, the CU may perform packet concatenation to reduce the overhead in terms of processing latency and/or processing resources usage (e.g., processor and/or memory usage) encountered through the protocol stack. As an example, the CU may receive, from an application server (e.g., a web server), multiple internet protocol (IP) packets (e.g., multiple SDUs) addressed to a UE, and the CU may combine or concatenate the IP packets into a single packet or data frame (e.g., a PDU). Concatenation of multiple packets into a single packet (or data frame) may enable a reduction in the total number of headers and/or the size of integrity protection bits added to the information flowing through the protocol stack of the RAN and then to the UE. Thus, concatenation of multiple packets may enable reduced usage of processing resources, reduced processing latencies, and/or reduced channel usage, for example, due to the non-trivial amount of time, processing resources, and/or channel resources that would be used to process or communicate the information without packet concatenation.

In certain cases, a CU may send a concatenated packet to a DU for further processing through lower layers of the protocol stack. However, it has not been established, for certain wireless communication systems (e.g., 5G NR systems or other suitable or future systems), on how to configure a DU to handle a concatenated packet from a CU. There may be a misalignment between the CU and the DU in terms of the maximum payload size available for a downlink transmission to the UE. For example, the CU may generate a concatenated packet that exceeds the grant size available for downlink communications to the UE. Then, the DU may perform packet segmentation on a concatenated packet at certain protocol stack layer(s), for example, due to a relatively low modulation and coding scheme (MCS) used for wireless communications with the UE located at a cell edge. Thus, the packet segmentation at the DU on a concatenated packet may affect the performance of wireless communications, for example, in terms of processing latencies, processing resource usage, and/or channel resource usage.

Certain aspects described herein may overcome the aforementioned technical problem(s), for example, by providing scheme(s) for packet concatenation in a RAN (such as a disaggregated RAN) that may enable reduced processing latencies, reduced processing resources usage, and/or reduced channel usage. In certain aspects, a first network node (e.g., a CU) may configure a second network node (e.g., a DU) with certain parameter(s) (hereinafter “concatenated packet parameters”) associated with communication of a concatenated packet or segmentation thereof. As an example, the concatenated packet parameters may include a minimum grant size (e.g., a transport block size) that can be used for a downlink transmission between the second network node and a UE. The minimum grant size may prevent segmentation or reduce the number of segments formed from a concatenated packet at or by the second network node. In certain aspects, the concatenated packet parameters may include an indication for the second network to report feedback associated with downlink communications, such as past performance.

In certain aspects, the second network node may provide, to the first network node, certain information related to the downlink communications between a UE and the second network node, such as expected behaviors and/or past performance. Such information may enable the first network node to determine the concatenated packet parameters (such as a value for the minimum grant size) for the second network node.

Certain techniques for packet concatenation configuration described herein may provide various beneficial technical effects and/or advantages. The techniques for packet concatenation configuration may enable improved wireless communications performance, such as reduced latencies, reduced processing resource usage, improved channel usage, and/or the like. The reduced latencies, reduced processing resource usage, or improved channel usage may be attributable to enabling communication of a concatenated packet through a disaggregated RAN to a UE without segmentation. For example, the packet concatenation configuration may ensure a CU and DU are in alignment with respect to the expected size of a concatenated packet and in turn the expected grant size for downlink transmissions to a UE. Such an alignment between the CU and DU may prevent or reduce the occurrence of a concatenated packet, which is passed to a DU, from being segmented into multiple packets, and thus, affecting the processing latencies, processing resource usage, and channel usage for information to be transferred to a UE.

### Introduction to Wireless Communications Networks

The techniques and methods described herein may be used for various wireless communications networks. While aspects may be described herein using terminology commonly associated with 3G, 4G, 5G, 6G, and/or other generations of wireless technologies, aspects of the present disclosure may likewise be applicable to other communications systems and standards not explicitly mentioned herein.

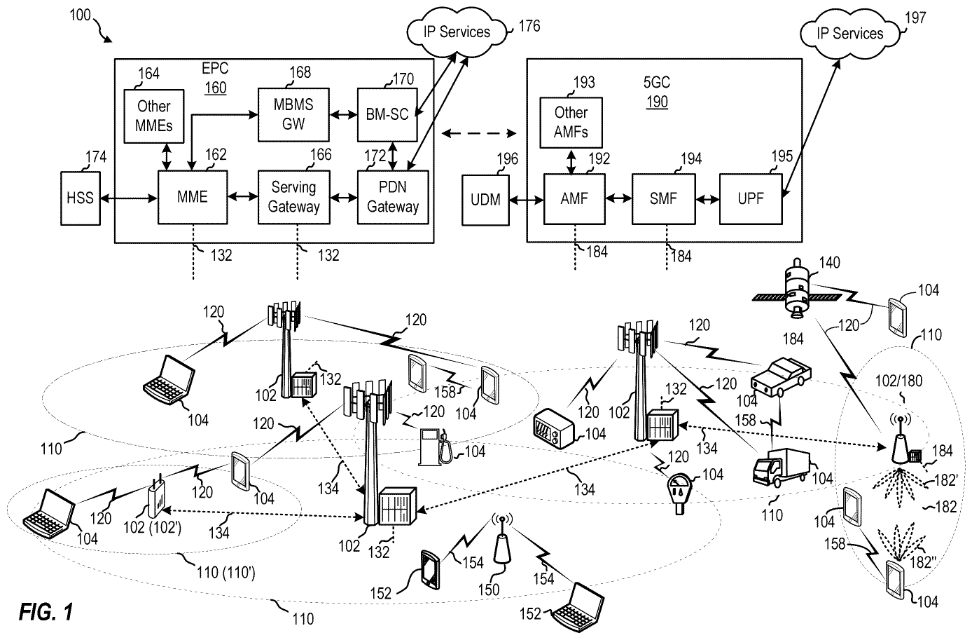

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). As such communications devices are part of wireless communications network 100, and facilitate wireless communications, such communications devices may be referred to as wireless communications devices. For example, various functions of a network as well as various devices associated with and interacting with a network may be considered network entities. Further, wireless communications network 100 may include terrestrial aspects, such as ground-based network entities (e.g., BSs 102), and non-terrestrial aspects (also referred to herein as non-terrestrial network entities). A non-terrestrial network entity may include satellite 140, which may be an example of an aerial or space-borne platform. In some examples, satellite 140 may include one or more network entities on-board (e.g., one or more BSs) capable of communicating with other network elements (e.g., terrestrial BSs) and UEs. For example, satellite 140 may be implemented according to a regenerative architecture (also referred to as a non-transparent architecture), and a gNB implemented at satellite 140 may implement higher-layer network functions. As another example, satellite 140 may be implemented according to a transparent architecture, and may perform a physical or other lower-layer repeater function for UEs and a network entity (such as a gateway associated with the satellite 140).

In the depicted example, wireless communications network 100 includes BSs 102, UEs 104, and one or more core networks, such as an Evolved Packet Core (EPC) 160 or a 5G Core (5GC) network 190, which interoperate to provide communications services over various communications links, including wired and wireless links. In some aspects, a core network, such as a 6G core, may implement a converged service-based architecture. In a converged service-based architecture, functions traditionally split between a core network (such as 5GC network 190) and a radio access network (RAN) (such as BS 102) may be implemented at a single network entity. For example, a mobility network entity may perform both core network functions and RAN functions related to mobility of UEs 104 attached to the wireless communications network 100. “Network entity” can refer to a BS 102, a network entity of EPC 160 or 5GC network 190, or a network entity of a converged service-based architecture.

FIG. 1 depicts various example UEs 104. UE 104 may include a cellular phone, a smart phone, a session initiation protocol (SIP) phone, a laptop, a personal digital assistant (PDA), a satellite radio, a Global Positioning System device, a multimedia device, a video device, a digital audio player, a camera, a game console, a tablet, a smart device, a wearable device, a vehicle, an electric meter, a gas pump, a kitchen appliance, a healthcare device, an implant, a sensor/actuator, a display, an Internet of Things (IoT) device, an always on (AON) device, an edge processing device, a data center, or another similar device. A UE 104 may also be referred to as a mobile device, a wireless device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. A communications link 120 between a BS 102 and a UE 104 may include uplink (UL) (also referred to as reverse link) transmissions from a UE 104 to a BS 102 and/or downlink (DL) (also referred to as forward link) transmissions from a BS 102 to a UE 104. A communications link 120 may use multiple-input and multiple-output (MIMO) antenna technology, including spatial multiplexing, beamforming, and/or transmit diversity in various aspects.

A BS 102 may include a NodeB, an enhanced NodeB (eNB), a next generation enhanced NodeB (ng-eNB), a next generation NodeB (gNB or gNodeB), an access point, a base transceiver station, a radio base station, a radio transceiver, a transceiver function, a transmission reception point (TRP), a radio unit (RU), a distributed unit (DU), or the like. A given BS 102 may provide communications coverage for a coverage area 110, which may sometimes be referred to as a cell, and which may overlap another coverage area 110 (e.g., a small cell provided by a BS 102′) may have a coverage area 110′ that overlaps the coverage area 110 of a macro cell). A BS 102 may, for example, provide communications coverage for a macro cell (covering a relatively large geographic area), a pico cell (covering a relatively smaller geographic area, such as a sports stadium), a femto cell (covering a relatively smaller geographic area, such as a home), or another type of cell.

The term “cell” may refer to a portion, partition, or segment of wireless communication coverage served by a network entity within a wireless communications network 100. A cell may have geographic characteristics, such as a geographic coverage area, as well as radio frequency characteristics, such as time and/or frequency resources dedicated to the cell. For example, a specific geographic coverage area may be covered by multiple cells employing different frequency resources (e.g., bandwidth parts) and/or different time resources. As another example, a specific geographic coverage area may be covered by a single cell. In some contexts (e.g., a carrier aggregation scenario and/or multi-connectivity scenario), the terms “cell” or “serving cell” may refer to or correspond to a specific carrier frequency (e.g., a component carrier) used for wireless communications, and a “cell group” may refer to or correspond to multiple carriers used for wireless communications. As examples, in a carrier aggregation scenario, a UE may communicate on multiple component carriers corresponding to multiple (serving) cells in the same cell group, and in a multi-connectivity (e.g., dual connectivity) scenario, a UE may communicate on multiple component carriers corresponding to multiple cell groups.

While BSs 102 are depicted in various aspects as unitary communications devices, BSs 102 may be implemented in various configurations. For example, one or more components of a base station may be disaggregated, including a central unit (CU), one or more DUs, one or more RUs, a Near-Real Time (Near-RT) RAN Intelligent Controller (RIC), or a Non-Real Time (Non-RT) RIC, to name a few examples. In another example, various aspects of a base station may be virtualized. A base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. Implementing a base station in this fashion may provide efficiency gains by enabling cloud-based implementation of certain (e.g., non-time-sensitive) higher-layer functions while physical-layer or other lower-layer functions can be implemented at or in proximity to a geographic coverage area of a corresponding cell. In some aspects, a base station including components that are located at various physical locations may be referred to as having a disaggregated RAN architecture, such as an Open RAN (O-RAN) or Virtualized RAN (VRAN) architecture.

FIG. 2 depicts and describes an example disaggregated RAN architecture.

Different BSs 102 within wireless communications network 100 may also be configured to support different radio access technologies, such as 3G, 4G, 5G, and/or 6G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or the 5GC 190) with each other over third backhaul links 134 (e.g., an X2 or XN interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, the Third Generation Partnership Project (3GPP) currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-71,000 MHz, which is sometimes referred to (interchangeably) as a “millimeter wave” (“mmW” or “mmWave”). In some cases, FR2 may be further defined in terms of sub-ranges, such as a first sub-range FR2-1 including 24,250 MHz-52,600 MHz and a second sub-range FR2-2 including 52,600 MHz 71,000 MHz. A base station configured to communicate using mmWave/near mmWave radio frequency bands (e.g., a mmWave base station such as BS 180) may utilize beamforming (e.g., 182) with a UE (e.g., 104) to improve path loss and range.

A communications links 120 may be through one or more carriers, which may have different bandwidths (e.g., 5 MHz, 10 MHz, 15 MHz, 20 MHz, 100 MHz, 400 MHz, and/or other bandwidths), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., base station 180 in FIG. 1) may utilize beamforming (indicated by reference number 182) with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may perform beam training to determine suitable receive and transmit directions for each of BS 180 and UE 104. Notably, the transmit and receive directions for BS 180 may or may not be the same. Similarly, the transmit and receive directions for UE 104 may or may not be the same.

Wireless communications network 100 may include a Wi-Fi access point (AP) 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. In some examples, D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH). D2D communications link 158 may be implemented using a variety of technologies, such as a radio access technology (e.g., 5G, ProSe sidelink), a WiFi technology, a Bluetooth technology, or the like.

EPC 160 may include various functional components, such as a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172. MME 162 may be in communication with a Home Subscriber Server (HSS) 174. MME 162 is a control node that processes signaling between the UEs 104 and the EPC 160. Generally, MME 162 provides bearer and connection management.

Generally, user Internet protocol (IP) packets are transferred through Serving Gateway 166. Serving gateway 166 is connected to PDN Gateway 172. PDN Gateway 172 provides UE IP address allocation as well as other functions. PDN Gateway 172 and BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, such as an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and the 5GC 190. AMF 192 provides, for example, quality of service (QoS) flow and session management.

IP packets are transferred through UPF 195, which is connected to the IP Services 197. UPF 195 may provide UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a core network entity, or a sidelink node, to name a few examples.

FIG. 2 depicts an example disaggregated base station 200 architecture. The disaggregated base station 200 architecture may include one or more CUs 210 that can communicate directly with a core network 220 or other CUs 210 via a backhaul link (such as backhaul link 134), or indirectly with the core network 220 through one or more disaggregated base station units (such as a Near-Real Time (Near-RT) RAN Intelligent Controller (RIC) 225 via an E2 link, a Non-Real Time (Non-RT) RIC 215 associated with a Service Management and Orchestration (SMO) Framework 205, or both). A CU 210 may communicate with one or more DUs 230 via respective midhaul links, such as an F1 interface. The DUs 230 may communicate with one or more RUs 240 via respective fronthaul links. The RUs 240 may communicate with respective UEs 104 via one or more radio frequency (RF) access links (such as communication link 120). In some implementations, a UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or a processor or controller providing instructions to the interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter, or a transceiver (such as a RF transceiver), configured to receive or transmit signals, or both, over a wireless transmission medium.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230 for network control and signaling.

The DU 230 may be or correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more DUs 230 and/or one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

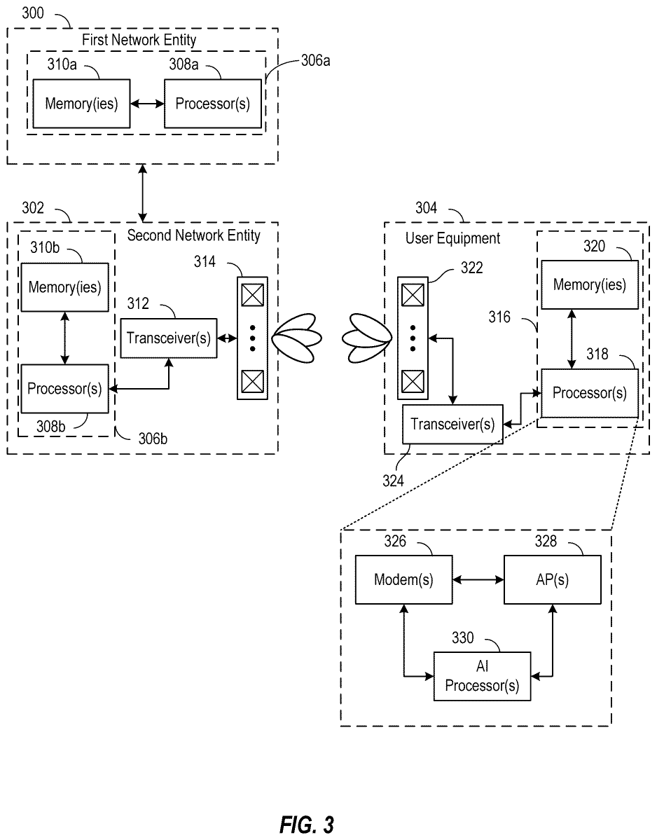

FIG. 3 depicts aspects of network entities 300 and 302 and a UE 304.

FIG. 3 includes a first network entity 300 and a second network entity 302. In some examples, first network entity 300 may be an example of a CU 210 or a DU 230. In some examples, second network entity 302 may be an example of a DU 230 or an RU 240. First network entity 300 and second network entity 302 may communicate with one another via a communications link, such as a midhaul link. In some examples, first network entity 300 and second network entity 302 may be implemented at a same BS (e.g., BS 102). For example, first network entity 300 and second network entity 302 may be co-located. In some other examples, first network entity 300 may be implemented separately from second network entity 302. For example, first network entity 300 may be implemented as a function (e.g., one or more processes) running on a server, such as in a cloud (e.g., a public or private cloud). As another example, first network entity 300 may be implemented as a virtual computing instance (e.g., virtual machine, container, etc.) or as a physical server.

First network entity 300 and second network entity 302 each include a processing system 306, illustrated as “processing system 306a” at first network entity 300 and “processing system 306b” at second network entity 302. For example, first network entity 300 and second network entity 302 may include one or more chips, system-on-chips (SoCs), system-in-packages (SiPs), chipsets, packages, or devices that individually or collectively constitute or comprise a processing system 306. A processing system 306 includes one or more processors 308 (illustrated as “processor(s) 308a” and “processor(s) 308b”) and one or more memories 310 (illustrated as “memory(ies) 310a” and “memory(ies) 310b”) coupled to the one or more processors 308. The one or more processors 308 may include one or multiple processors, microprocessors, processing units (such as central processing units (CPUs), graphics processing units (GPUs), neural processing units (NPUs) (also referred to as neural network processors or deep learning processors (DLPs)) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (any one or more of which may be generally referred to herein individually as a “processor” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

In some aspects, the processing system 306 may perform processing (such as digital signal processing) of data, control information, or signals received or transmitted by a network entity. For example, the processing system 306 may include a coder, a decoder, a multiplexer, a demultiplexer, a transmit MIMO processor, a transmit processor, a receive processor, a receive MIMO detector, an automatic gain control component, or the like.

The one or more memories 310 may include one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). The one or more memories 310 may store data and program code for first network entity 300 and/or second network entity 302.

As further shown, second network entity 302 includes one or more transceivers 312 (illustrated as “transceiver(s) 312”). The one or more transceivers 312 may perform processing related to implementing physical layer (e.g., radio, air interface) communication with other devices such as UE 304. The one or more transceivers 312 may include one or more radio frequency (RF) components, such as an RF transceiver, a front-end module (e.g., an RF front-end (RFFE)), or the like. For example, the one or more transceivers 312 may include a transmit path (also referred to as a transmit chain), a receive path (also referred to as a receive chain), and/or an interface with one or more antennas 314.

The one or more antennas 314 may perform wireless transmission and reception of signals. The one or more antennas 314 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 3.

UE 304 may be an example of UE 104. As shown, UE 304 includes a processing system 316. For example, UE 304 may include one or more chips, SoCs, SiPs, chipsets, packages, or devices that individually or collectively constitute or comprise a processing system 316. A processing system 316 includes one or more processors 318, and one or more memories 320 coupled to the one or more processors 318. Further, UE 304 includes one or more antennas 322, one or more transceivers 324, and/or other components that enable wireless transmission and reception of data.

The one or more processors 318 may include one or multiple processors, microprocessors, processing units (such as CPUs, GPUs, NPUs (also referred to as neural network processors or DLPs) and/or DSPs), processing blocks, ASICs, PLDs (such as FPGAs), or other discrete gate or transistor logic or circuitry (any one or more of which may be generally referred to herein individually as a “processor” or collectively as “the processor” or “the processor circuitry”). One or more of the processors may be individually or collectively configurable or configured to perform various functions or operations described herein. In some aspects, the processing system 316 may perform processing (such as digital signal processing) of data, control information, or signals received or transmitted by a network entity. For example, the processing system 316 may include a coder, a decoder, a multiplexer, a demultiplexer, a transmit MIMO processor, a transmit processor, a receive processor, a receive MIMO detector, an automatic gain control component, or the like.

As shown, in some examples, the one or more processors 318 may include one or more modems 326, one or more application processors (APs) 328, one or more AI processors 330, a combination thereof, and/or another form of processor.

The one or more modems 326 may include a digital signal processor that converts information into a waveform for analog signal transmission (e.g., via modulation) and/or converts the waveform of a received signal into information (e.g., via demodulation). The one or more modems 326 may process information or waveforms in connection with signal transmission or reception. For example, the one or more modems 326 may include a coder, a decoder, a multiplexer, a demultiplexer, a transmit MIMO processor, a transmit processor, a receive processor, a receive MIMO detector, an automatic gain control component, or the like.

The one or more APs 328 may perform processing relating to an operating system and/or a higher layer application of the UE 304. For example, the one or more APs 328 may provide a higher-level operating system (HLOS), software, audio or video processing, graphics processing, or the like. In some examples, the one or more APs 328 may be a data source (e.g., for transmissions) or a data sink (e.g., for receptions).

The one or more transceivers 324 may perform processing related to implementing physical layer (e.g., radio, air interface) communication with other devices such as other UEs 304 or second network entity 302. The one or more transceivers 324 may include one or more RF components, such as an RF transceiver, a front-end module (e.g., an RFFE), or the like. For example, the one or more transceivers 324 may include a transmit path (also referred to as a transmit chain), a receive path (also referred to as a receive chain), and/or an interface with one or more antennas 322.

The one or more antennas 322 may perform wireless transmission and reception of signals. The one or more antennas 322 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 3.

For an example downlink transmission by second network entity 302, the processing system 306 (e.g., a transmit processor) may receive data and/or control information. The control information may be for the physical broadcast channel (PBCH), physical control format indicator channel (PCFICH), physical hybrid automatic repeat request (HARQ) indicator channel (PHICH), physical downlink control channel (PDCCH), group common PDCCH (GC PDCCH), and/or others. The data may be for the physical downlink shared channel (PDSCH), in some examples.

The processing system 306 (e.g., a transmit processor) may process (e.g., encode and symbol map) the data and control information to obtain data symbols and control symbols, respectively. The processing system 306 may also generate reference symbols, such as for the primary synchronization signal (PSS), secondary synchronization signal (SSS), PBCH demodulation reference signal (DMRS), or channel state information reference signal (CSI-RS).

The processing system 306 (e.g., a TX MIMO processor) may perform spatial processing (e.g., precoding) on the data symbols, the control symbols, and/or the reference symbols, if applicable, and may provide output symbol streams to one or more modulators of the processing system 306. The one or more modulators may process one or more respective output symbol streams to obtain an output sample stream. The one or more transceivers 312 may process (e.g., convert to analog, amplify, filter, and upconvert) the output sample stream to obtain a downlink signal. Second network entity 302 may transmit the downlink signal via the one or more antennas 314.

In order to receive the downlink transmission at UE 304 (or a sidelink transmission from another UE), the one or more antennas 322 may receive the downlink signal and may provide received signals to the one or more transceivers 324. The one or more transceivers 324 may condition (e.g., filter, amplify, downconvert, and digitize) the received signals to obtain input samples. The one or more transceivers 324 and/or the processing system 316 may further process the input samples to obtain received symbols.

The processing system 316 (e.g., modem 326, an RX MIMO detector) may obtain the received symbols, perform MIMO detection on the received symbols if applicable, and provide detected symbols. The processing system 316 (e.g., a modem 326, a receive processor) may process (e.g., de-interleave and decode) the detected symbols. The processing system 316 may provide decoded data for the UE 304 (e.g., to an AP 328) and/or decoded control information (e.g., to a controller/processor of the processing system 316).

For an example uplink transmission or a sidelink transmission from UE 304, the processing system 316 (e.g., modem 326, a transmit processor) may receive and process data and/or control information to obtain a set of symbols for transmission. The data may be for the physical uplink shared channel (PUSCH), and may be received from a data source such as the AP 328. The control information may be for the physical uplink control channel (PUCCH), and may be received, for example, from a controller/processor of the processing system 316. The processing system 316 (e.g., a modem 326, the transmit processor) may also generate reference symbols for a reference signal (e.g., for a sounding reference signal (SRS), a demodulation reference signal, a phase tracking reference signal, or the like). In some examples, the symbols and/or reference signals may be precoded by the processing system 316 (e.g., modem 326, a TX MIMO processor), further processed by the one or more transceivers 324 (e.g., for SC-FDM), and transmitted to second network entity 302.

At second network entity 302, the uplink signals from UE 304 may be received by the one or more antennas 314, conditioned by the one or more transceivers 312 (e.g., filtered, amplified, downconverted, and digitized), detected (e.g., by the processing system 306b such as a modem and/or an RX MIMO detector), and further processed by the processing system 306b (e.g., a modem and/or a receive processor) to obtain decoded data and control information sent by UE 304. The processing system 306b may provide the decoded data and the decoded control information (such as to a controller/processor of the processing system 306b, an AP, first network entity 300, or another entity).

In various aspects, a wireless communication device, such as first network entity 300, second network entity 302, BS 102, UE 104, or UE 304 may be described as sending, transmitting, obtaining, or receiving various types of data associated with the methods described herein. In these contexts, “transmitting” or “sending” may refer to various mechanisms of outputting data, such as outputting data from a processing system, one or more memories, one or more transceivers, one or more antennas, and/or other aspects described herein. For example, “sending” or “transmitting” by a device may include sending (such as wirelessly, via a wired connection, or both) to a recipient directly or via another device. As another example, “sending” or “transmitting” may include sending internally to a device (such as the UE 304, first network entity 300, or second network entity 302) by a process to memory. “Receiving” or “obtaining” may refer to various mechanisms of obtaining data, such as obtaining data from the processing system, one or more memories, one or more transceivers, one or more antennas, and/or other aspects described herein. For example, “receiving” or “obtaining” by a device may include obtaining (such as wirelessly, via a wired connection, or both) from a recipient directly or via another device. As another example, “receiving” or “obtaining” may include obtaining internally to a device (such as the UE 304, first network entity 300, or second network entity 302) by a process from memory. As used herein, “communicating” by a device may include sending, obtaining, receiving, and/or transmitting a communication. “Communicating” can refer to communication with another device or internal communication of the device.

In various aspects, the processing system 306 or the processing system 316 may include one or more AI processors (such as AI processor 330 of the processing system 316). An AI processor may perform AI processing. The AI processor may include AI accelerator hardware or circuitry such as one or more neural processing units (NPUs), one or more neural network processors, one or more tensor processors, one or more deep learning processors, etc. As an example, the AI processor may perform AI-based beam management, AI-based channel state feedback (CSF), AI-based antenna tuning, and/or AI-based positioning (e.g., non-line of sight positioning prediction). In some cases, at the UE 104, the AI processor may process feedback generated by the UE 304 (e.g., CSF) using hardware accelerated AI inferences and/or AI training. In some cases, at the second network entity 302, the AI processor may decode compressed CSF from the UE 304, for example, using a hardware accelerated AI inference associated with the CSF. In certain cases, the AI processor may perform certain RAN-based functions including, for example, network planning, network performance management, energy-efficient network operations, etc.

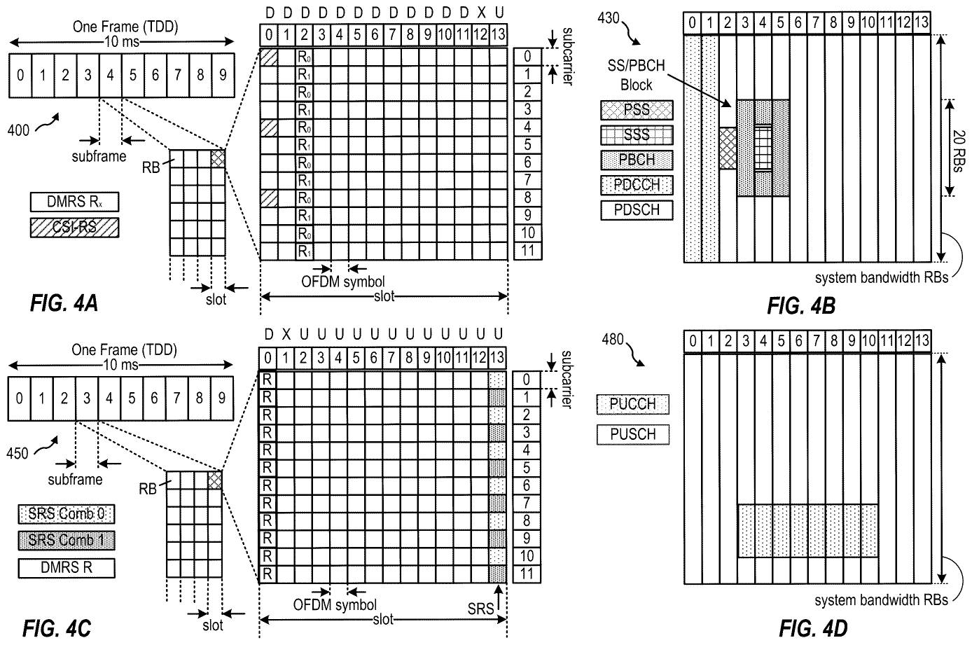

FIGS. 4A, 4B, 4C, and 4D depict aspects of data structures for a wireless communications network, such as wireless communications network 100 of FIG. 1.

FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. One or more subcarriers may be modulated with data. Modulation symbols may be sent in the frequency domain with OFDM and/or in the time domain with SC-FDM.

In some examples, a wireless communications frame structure may be implemented using frequency division duplexing (FDD). In FDD, some subcarriers may be configured for DL communication, and other subcarriers (which may overlap in time with the DL subcarriers) may be configured for UL communication. In some other examples, wireless communications frame structures may be implemented using time division duplexing (TDD). In TDD, for a particular set of subcarriers, some subframes are configured for DL communication and other subframes are configured for UL communication.

In FIGS. 4A and 4C, the wireless communications frame structure is implemented using TDD. “D” indicates DL time resources, “U” indicates UL time resources, and “X” indicates flexible time resources for use or later reconfiguration for either DL or UL communication. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 12 or 14 symbols, depending on the cyclic prefix (CP) type (e.g., 12 symbols per slot for an extended CP or 14 symbols per slot for a normal CP). Subframes may also include mini-slots, which generally have fewer symbols than an entire slot. Other wireless communications technologies may have a different frame structure and/or different channels.

In certain aspects, the number of slots within a subframe (e.g., a slot duration in a subframe) is based on a numerology. A numerology may define a frequency domain subcarrier spacing and symbol duration, and may be configured for a given bandwidth part, carrier, cell, or network entity. In certain aspects, given a numerology μ, there are 2^{μ} slots per subframe. Thus, numerologies (μ) 0 to 6 may allow for 1, 2, 4, 8, 16, 32, and 64 slots, respectively, per subframe. In some cases, an extended CP (e.g., 12 symbols per slot) may be used with a specific numerology, such as numerology μ=2 allowing for 4 slots per subframe. The subcarrier spacing and symbol length/duration are a function of the numerology. The subcarrier spacing may be equal to 2^{μ}×15 kHz. As an example, the numerology μ=0 corresponds to a subcarrier spacing of 15 kHz, and the numerology μ=6 corresponds to a subcarrier spacing of 960 kHz. The symbol length/duration is inversely related to the subcarrier spacing. FIGS. 4A, 4B, 4C, and 4D provide an example of a slot format having 14 symbols per slot (e.g., a normal CP) and a numerology μ=2 with 4 slots per subframe. In such a case, the slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as a physical RB (PRB)) that extends across, for example, 12 consecutive subcarriers. The resource grid is divided into multiple resource elements (REs). An RE may include a single subcarrier in the frequency domain and a single symbol in the time domain. The number of bits carried by each RE depends on the modulation scheme including, for example, quadrature phase shift keying (QPSK) or quadrature amplitude modulation (QAM).

As illustrated in FIG. 4A, some of the REs carry reference (pilot) signals (shown as “RS”) for a UE (e.g., UE 104 of FIGS. 1 and 3). The RS may include a demodulation RS (DMRS) and/or a channel state information reference signals (CSI-RS) for channel estimation at the UE. The RS may additionally or alternatively include a beam measurement RS (BRS), a beam refinement RS (BRRS), and/or a phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block (SSB), and in some cases, referred to as a synchronization signal block (SSB). The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as “R” for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Example Protocol Stacks

Certain wireless communications systems (e.g., 5G NR systems or any other suitable or future wireless communications system) may employ protocol stack(s) to transfer information between a UE and a network node, such as a base station and/or core network. As an example, 5G NR systems may use a user plane protocol stack and a control plane protocol stack to exchange application data and control signaling messages, respectively. A user plane protocol stack may be responsible for transferring application data between the UE and an application server (e.g., a web server or the like), and a control plane protocol stack may be responsible for transferring control signaling messages between the UE and a network node.

FIG. 5A depicts an example control plane protocol stack 500A for exchanging control plane traffic (e.g., control signaling) between a user equipment (UE) 504 and a network node 502, and between the UE 504 and a core network 590. In some aspects, the network node 502 may be an example of the BS and/or network entities depicted and described with respect to FIGS. 1 and 3 or a disaggregated base station depicted and described with respect to FIG. 2. Similarly, the UE 504 may be an example of UE depicted and described with respect to FIGS. 1 and 3. The core network 590 may be an example of the 5GC network 190 and/or the core network 220 depicted and described with respect to FIGS. 1 and 2, respectively.

The control plane protocol stack 500A includes a non-access stratum (NAS) layer 510, a radio resource control (RRC) layer 512, a packet data convergence protocol (PDCP) layer 514, a radio link control (RLC) layer 516, a medium access control (MAC) layer 518, and a physical (PHY) layer 520. The NAS layer 510 carries mobility management and session management signaling between the UE 504 and the core network 590 (e.g., the AMF 192 and/or the SMF 194 of FIG. 1). The RRC layer 512 carries RRC signaling, for example, for paging, RRC connection establishment, RRC connection reconfiguration, and RRC connection release. The PDCP layer 514 provides ciphering and integrity protection for control plane signaling. The RLC layer 516 may segment a large packet into smaller packets and handles re-transmissions of RLC packets. The MAC layer 518 schedules transmissions between the UE 504 and the network node 502 and controls the PHY layer. In the MAC layer 518, the UE 504 and the network node 502 may communicate with each other by exchanging a MAC control element (MAC-CE). The PHY layer 520 handles transmission and reception across the air-interface between the UE 504 and the network node 502. The PHY layer 520 provides certain error management tasks (e.g., cyclic redundancy check), certain digital signaling processing tasks (e.g., modulation and demodulation), and handles certain procedures for measurement and control (e.g., beam failure detection and/or radio link monitoring). The network node 502 may send, to the UE 504, PHY layer signaling via downlink control information (DCI).

FIG. 5B depicts an example user plane protocol stack 500B for exchanging user plane traffic (e.g., application data) between the UE 504 and the network node 502. The user plane protocol stack 500B includes a service data adaptation protocol (SDAP) layer 522, the PDCP layer 514, the RLC layer 516, the MAC layer 518, and the PHY layer 520. The SDAP layer 522 maps the quality of service (QoS) flow(s) used at the core network 590 (e.g., for a protocol data unit (PDU) session) to data radio bearer(s) used at the network node 502 to communicate via an air-interface between the UE 504 and the network node 502. In the user plane, the PDCP layer 514 provides packet header compression (e.g., transmission control protocol (TCP), user datagram protocol (UDP), and/or internet protocol (IP) header compression), ciphering, and integrity protection for user plane traffic.

The RRC layer 512 may form Layer-3 (L3) of the control plane protocol stack 500A. In the user plane, the SDAP layer 522, the PDCP layer 514, the RLC layer 516, and/or the MAC layer 518 may form Layer-2 (L2) of the user plane protocol stack 500B. In the control plane, the PDCP layer 514, the RLC layer 516, and/or the MAC layer 518 may form L2 of the control plane protocol stack 500A. The PHY layer 520 may form Layer-1 (L1) of the protocol stacks 500A, 500B. Layer-3 may include the highest or upper layers in the control plane protocol stack 500A; Layer-2 may include the intermediate layers in the control plane protocol stack 500A, where Layer-2 is arranged between Layer-3 and Layer-1; and Layer-1 may include the lowest layer in the control plane protocol stack 500A.

### Aspects Related to Protocol Stack Concatenation Configuration

Aspects of the present disclosure provide certain schemes for communication of a concatenated packet in a RAN (such as a disaggregated RAN) that may enable reduced processing latencies, reduced processing resources usage, and/or reduced channel usage, as further described herein.

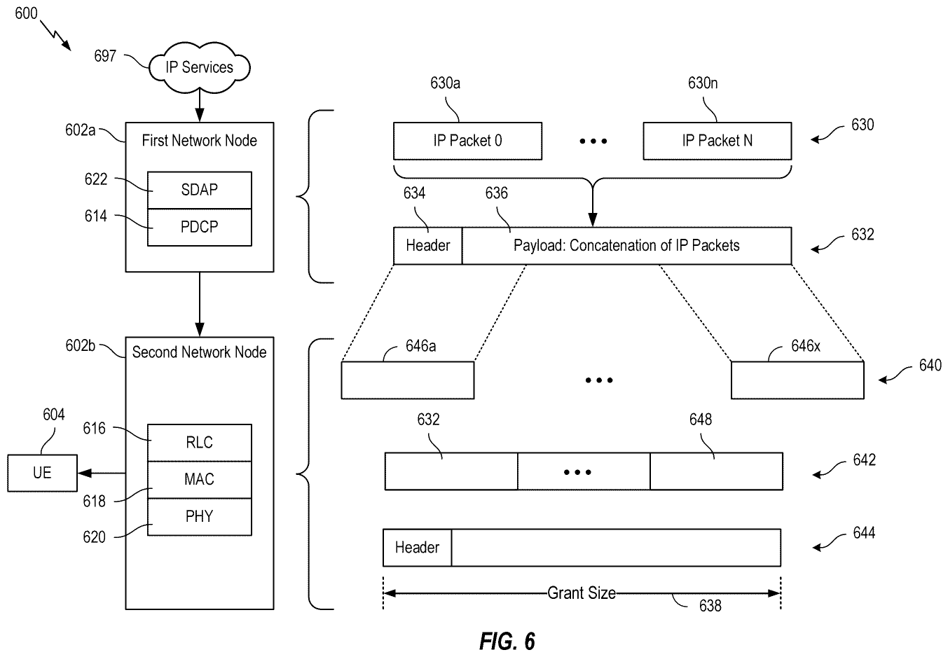

FIG. 6 depicts an example scheme 600 for downlink data flow of a concatenated packet, for example, through a disaggregated RAN to a UE. In this example, the disaggregated RAN may communicate with a UE 604 via a wireless communication link. The disaggregated RAN may include at least a first network node 602a and a second network node 602b. The first network node 602a may be an example of the CU 210 of FIG. 2 and/or the first network entity 300 of FIG. 3; and the second network node 602b may be an example of the DU 230 of FIG. 2, the RU 240 of FIG. 2, and/or the second network entity 302 of FIG. 3.

In certain aspects, a protocol stack may be split among the first network node 602a and the second network node 602b. As an example of a split across a user plane protocol stack (e.g., the user plane protocol stack 500B of FIG. 5B), the first network node 602a may be configured to perform operations at the SDAP layer 622 and/or the PDCP layer 614 of the protocol stack; and the second network node 602b may be configured to perform operations at the RLC layer 616, the MAC layer 618, and the PHY layer 620 of the protocol stack.

Note that the protocol stack and corresponding layers depicted in FIG. 6 are merely examples to facilitate an understanding of communication of a concatenated packet through a disaggregated RAN. Aspects of the present disclosure may apply to additional or alternative protocol stacks (e.g., the control plane protocol stack 500A of FIG. 5A) and/or additional or alterative layer splits among network nodes in which a concatenated packet is passed from one network node to another network node (for example, from a CU to a CU, a DU to a DU, a DU to an RU, an RU to an RU, or the like).

In certain aspects, the first network node 602a may obtain, from one or more IP services 697, a plurality of packets 630 addressed to the UE 604, for example, for downlink transmission via one or more data radio bearers (DRBs). The packets 630 may be or include IP packets including a first IP packet 630a and an nth IP packet 630n. The packets 630 may include or indicate a destination address (e.g., an IP address, a domain name, or a unique identifier) associated with or assigned to the UE 604. The IP services 697 may be an example of the IP services 197 of FIG. 1. The first network node 602a may concatenate the packets 630 into a concatenated packet 632. As an example, the IP packets 630a, 630n may be examples of SDUs obtained at the SDAP layer 622, and the concatenated packet 632 may be or include a PDU (e.g., a data frame or a packet) encapsulated at the SDAP layer 622 and passed to the PDCP layer 614. In certain cases, the concatenated packet 632 may include a header 634 and a payload 636, where the payload 636 includes a concatenation of the packets 630 (e.g., SDAP SDUs).

The first network node 602a may send, to the second network node 602b, a data frame (e.g., the concatenated packet 632 or a further encapsulation thereof) associated with a first protocol stack layer (e.g., the SDAP layer 622 and/or the PDCP layer 614) and addressed to the UE 804. As used herein, a data frame may refer to a unit of data, such as a packet, SDU, or PDU. The association between the data frame and the first protocol stack layer may refer to the data frame being formed (e.g., encapsulated or generated) at the first protocol stack layer, for example, at the SDAP layer 622.

The first network node 602a may configure the second network node 602b with certain concatenated packet parameter(s) associated with communication of a concatenated packet, segmentation thereof, and/or concatenation thereof, for example, through the protocol stack layer(s) served at or by the second network node 602b. In certain cases, the concatenated packet parameter(s) may indicate or include a minimum grant size for downlink communications (for example, between the second network node and the UE). A grant size 638 may refer to the transport block size allocated for a downlink transmission. As an example, the grant size 638 may be or include the size of the MAC PDU passed to the PHY layer 620 from the MAC layer 618. The minimum grant size may specify the smallest grant size allowed for downlink communication of a concatenated packet, for example, via a given radio bearer (e.g., a communication link between the UE and the RAN). The minimum grant size may define the minimum grant size allocated to the given radio bearer. The minimum grant size may be indicated in terms of a number of bits, a number of bytes, a number of segmented packets (e.g., PDUs) in the payload of the transport block, or the like.

The concatenated packet parameter(s) may indicate or include a maximum size of the concatenated packet (e.g., the size of the SDAP PDU and/or PDCP PDU) that is allowed to be passed to the second network node 602b. The concatenated packet parameter(s) may indicate or include a burst arrival time or a burst size associated with the concatenated packet. For example, the concatenated packet may be part of a burst of downlink traffic being communicated to the UE 604, where multiple packets (including the concatenated packet) may be provided to the second network node 602b in subsequent occasions over time. The burst arrival time may indicate one or more time occasions in which the second network node 602b may expect to receive a concatenated packet. The burst size may indicate the total number of packets in the traffic burst, the data size of the traffic burst (e.g., the overall data size of the packets in the traffic burst), and/or the size of each packet in the traffic burst. Thus, the first network node 602a may notify the second network node 602b of characteristics of the downlink traffic addressed to the UE, such as the time(s) at which to expect to receive a concatenated packet and/or the corresponding size of the concatenated packet.

The concatenated packet parameter(s) may include an indication of whether segmentation of the concatenated packet is enabled or disabled (e.g., allowed or disallowed). As an example, the indication may indicate that segmentation of the concatenated packet is disabled, and the second network node 602b may refrain from performing segmentation of the concatenated packet 632 (including the header 634 and the payload 636). In certain aspects, the indication may indicate whether segmentation of the header 634 of the concatenated packet 632 is enabled or disabled. As an example, the indication may indicate that segmentation of the header 634 of the concatenated packet 632 is disabled. The second network node 602b may refrain from performing segmentation of the header 634 of the concatenated packet 632, and the second network node 602b may be allowed to segment the payload 636 of the concatenated packet 632.

The concatenated packet parameter(s) may indicate or include a timer that indicates a time at which to activate or enable segmentation of the concatenated packet 632, for example, after segmentation is disabled. The timer may be an inactivity timer that specifies the time at which segmentation may be enabled after there has been no downlink transmissions of a threshold size for a certain period of time. As an example, the first network node 602a may configure the second network node 602b with a timeout period that allows the second network node to segment a packet (e.g., an RLC SDU) after the second network node 602b does not detect a downlink grant of a specified size for the duration of the timeout period. The timer may be initiated after the second network node 602b receives an indication to the start the timer, for example, an indication to activate the concatenated packet parameters and/or upon receiving a concatenated packet.

The concatenated packet parameter(s) may indicate or include a grant size scaling factor (e.g., an integer value of 1, 2, 3, or the like) and/or a base grant size (for example, also referred to as a grant size granularity of S bits or bytes), such that a product of the grant size scaling factor and the base grant size (e.g., 1S, 2S, 3S, or the like) indicates the expected grant size for downlink communications. In certain cases, the base grant size may correspond to the minimum grant size described herein In certain cases, the base grant size or grant size granularity may represent the size of the grant or a portion thereof allocated to a logical channel (such as a dedicated traffic channel), an RLC entity, a transport channel (such as a downlink shared channel), a MAC entity, and/or a protocol layer served at or by the second network node 602b for downlink communications with the UE 604. In certain aspects, the base grant size and/or the grant size scaling factor may indicate that the grant size is expected to be a multiple of the base grant size (e.g., 1S, 2S, 3S, etc., where S is 3000 or 6000 bytes) for a particular radio bearer. The base grant size may enable alignment between the first network node 602a and the second network node 602b in terms of the number of SDUs that may be concatenated at the first network node 602a and that does not lead to segmentation at the second network node 602b. For example, a grant size scaling factor of 3 may indicate that the first network node 602a can concatenate up to 3 SDUs of size S (e.g., the base grant size) without the second network node 602b performing segmentation on the given concatenated packet. Thus, the grant size scaling factor and the base grant size may indicate the maximum size of a concatenated packet (which can be passed through the protocol layers of the second network entity 602b without segmentation) and the total number of packets that are expected to be included in the payload of a concatenated packet.

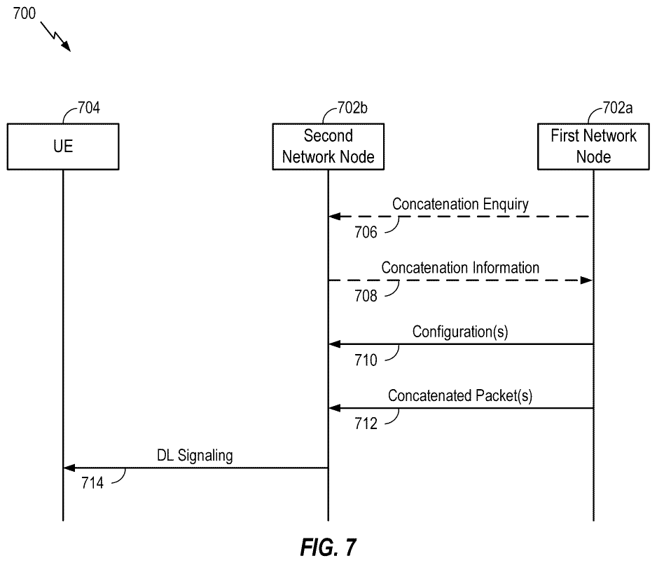

In certain aspects, the second network node 602b may provide, to the first network node 602a, certain information associated with the concatenated packet parameter(s). As an example, the second network node 602b may provide, to the first network node 602a, capability information associated with communication of a concatenated packet, for example, as further described herein with respect to FIG. 7.

In certain cases, the second network node 602b may provide proactive information, such as information about the expected behavior of downlink communications with the UE 604. As an example, the information may include the recommended, preferred, or expected values for the concatenated packet parameter(s). The information may include, for example, a minimum grant size for downlink communications, a maximum grant size for downlink communications, a grant size scaling factor (and/or a base grant size) for downlink communications, a grant allocation periodicity (e.g., a recommended arrival periodicity for a burst of concatenated packets), a maximum data frame size (e.g., the maximum size of a concatenated packet), and/or a minimum data frame size.

In certain cases, the second network node 602b may provide reactive or past information, such as information about the past performance of downlink communications with the UE 604 and/or other UE(s). The past performance information may indicate the statistics associated with past downlink communications, such as a median value, a mean value, a minimum value, a peak value, etc. of the grant size over a past time window (e.g., 1 minute, 10 minutes, 1 hour, or the like). The past performance information may include an indication of a grant size allocated for downlink communications over a past time window, an indication of a segmentation rate associated with data frame(s) (e.g., concatenated packets) over the past time window, and/or an indication of a data frame size (e.g., the concatenated packet size) communicated over the past time window. The segmentation rate may indicate how often a concatenated packet was segmented into 2, 3, 4, etc. segments over the past time window.

The second network node 602b may perform various operations on the concatenated packet or an encapsulation thereof in accordance with the concatenated packet parameter(s), such as packet segmentation 640, packet concatenation 642, and/or packet encapsulation 644 of the concatenated packet 632. In certain cases, the second network node 602b may perform packet segmentation 640 (e.g., data frame segmentation) on the concatenated packet 632. As an example, the second network node 602b may segment the concatenated packet 632 into a plurality of data frames (e.g., packets or PDUs), for example, including a first data frame 646a and an nth data frame 646x, where the total number of segments satisfies the maximum number of segmented packets, for example, configured as part of the concatenated packet parameter(s). In certain cases, the second network node 602b may resume segmentation of packets after an inactivity timer expires, for example, configured as part of the concatenated packet parameter(s).

In certain cases, the second network node 602b may perform packet concatenation 642 (e.g., data frame concatenation) of the concatenated packet 632. As an example, the second network node 602b may concatenate the concatenated packet 632 with other packet(s) 648 into a data frame (for example, a MAC PDU). As an example, the concatenated data frame formed at the second network node 602b may satisfy the minimum grant size configured as part of the concatenated packet parameter(s).

In certain cases, the second network node 602b may perform packet encapsulation 644 (e.g., data frame encapsulation) of the concatenated packet 632. The second network node 602b may encapsulate the concatenated packet 632 into a data frame (for example, a MAC PDU). The encapsulated packet may satisfy a minimum grant size, for example, configured as part of the concatenated packet parameter(s). For example, the grant size associated with the encapsulated packet may be less than or greater than the minimum grant size.

The concatenated packet parameter(s) may ensure or enable effective communication of the concatenated packet through the protocol stack split among the first network node 602a and the second network node 602b. The concatenated packet parameter(s) may ensure the first network node 602a and the second network node 602b are aligned in terms how to communicate a concatenated packet through the protocol stack layer(s) served at or by the second network node 602b. As an example, the first network node 602a and the second network node 602b may be aware of the minimum grant size configured as part of the concatenated packet parameter(s); and the first network node 602a may pass, to the second network node 602b, a concatenated packet that enables the second network node 602b to meet the minimum grant size without packet segmentation or with reduced packet segmentation (e.g., meeting the maximum number of segmented packets). The concatenated packet parameter(s) may prevent or reduce the packet segmentation performed on a concatenated packet at or by the second network node 602b. Accordingly, the concatenated packet parameter(s) may enable reduced latencies, reduced processing resource usage, improved channel usage, and/or the like, for example, due to the prevention of packet segmentation or reduction in packet segmentation.

Note that the disaggregated RAN architecture depicted in FIG. 6 is an example of network node disaggregation. Aspects of the present disclosure may apply to additional or alternative disaggregation architectures, such as three or more network nodes being part of a disaggregated RAN architecture. In certain cases, aspects of the present disclosure may apply to communications between entities in a protocol stack of the same network node, such as between an SDAP entity and a MAC entity served at or by the same network node.

### Example Signaling of Protocol Stack Concatenation Configuration

FIG. 7 depicts a process flow 700 for communication of protocol stack concatenation configuration in a system including a first network node 702a, a second network node 702b, and a UE 704.

In some aspects, the first network node 702a, 702b may be an example of the BS 102 depicted and described with respect to FIG. 1, the first network entity 300 or the second network entity 302 depicted and described with respect to FIG. 3, or a disaggregated base station depicted and described with respect to FIG. 2. Similarly, the UE 704 may be an example of UE 104 depicted and described with respect to FIG. 1 or the UE 304 depicted and described with respect to FIG. 3. However, in other aspects, UE 704 may be another type of wireless communications device, and network node 702a, 702b may be another type of network entity or network node, such as those described herein. Note that any operations or signaling illustrated with dashed lines may indicate that that operation or signaling is an optional or alternative example.

In this example, a protocol stack may be split among the first network node 702a and the second network node 702b, for example, as described herein with respect to FIG. 6. The first network node 702a may be an example of the first network node 602a of FIG. 6; the second network node 702b may be an example of the second network node 602b of FIG. 6; and the UE 704 may be an example of the UE 604 of FIG. 6.

At 706, the first network node 702a optionally sends, to the second network node 702b, an enquiry message that requests, from the second network node 702b, certain information associated with communication of a concatenated packet, for example, through at least the portion of the protocol stack served at or by the second network node 702b. The enquiry message may request capability information associated with the capability of the second network node 702b to process a concatenated packet. In certain cases, the enquiry message may request recommended concatenated parameter(s) from the second network node 702b, for example, as described herein with respect to FIG. 6. The enquiry message may be communicated via one or more midhaul links (such as an F1 interface), for example, as described herein with respect to FIG. 2.

At 708, the first network node 702a optionally obtains, from the second network node 702b, certain concatenation information associated with communication of a concatenated packet through the protocol stack. The concatenation information may include the capability information associated with the second network node 702b (for example, associated with data frame or packet segmentation). As an example, the capability information may indicate or include whether the second network node 702b supports any of the concatenated packet parameters described herein (such as activation-deactivation of packet segmentation), a maximum supported size of a concatenated packet (for example, the maximum SDU size passed from the first network node 702a), a maximum downlink data rate, etc.

In certain cases, the concatenation information may include the preferred, recommended, or expected concatenated packet parameters of the second network node 702b. For example, the concatenation information may indicate or include the minimum grant size, a maximum size of the concatenated packet, whether to enable or disable packet segmentation and/or packet header segmentation, the inactivity timer, the grant size scaling factor, the base grant size, or the like.

At 710, the first network node 702a sends, to the second network node 702b, one or more configurations that include an indication of the concatenated packet parameter(s). The concatenated packet parameter(s) may indicate the parameter(s) for communication of a concatenated packet, which is passed from the first network node 702b to the second network node 702b, through at least the portion of the protocol stack served at or by the second network node 702b. The concatenated packet parameter(s) may be associated with communication of a data frame (e.g., data frame segmentation, data frame concatenation, and/or data frame encapsulation) through the protocol stack layer(s) served at or by the second network node 702b. In certain aspects, the operations at 706, 708, and/or 710 may be performed before, after, as part of radio bearer establishment for the UE 704, such as data radio bearer and/or signaling radio bearer establishment.

In certain cases, the concatenated packet parameter(s) may be determined based at least in part on the concatenation information communicated at 708. As an example, the first network node 702a may set values or settings of the concatenated packet parameter(s) to satisfy the capability information and/or recommended parameters associated with the second network node 702b. As another example, the first network node 702a may set the concatenated packet parameter(s) to satisfy certain performance specifications, such as processing latencies, processing resource usage, and/or channel resource usage. Thus, the concatenated packet parameter(s) may be set to different values or settings from the capability information and/or recommended parameters associated with the second network node 702b.

In certain cases, the second network node 702b may optionally send, to the first network node 702a, an indication of whether the second network node 702b has applied or accepted the concatenated packet parameter(s). As an example, the second network node 702b may send an acknowledgement, which indicates the parameter(s) have been successfully applied, to the first network node 702a. As another example, the second network node 702b may send an indication that the concatenated packet parameter(s) will not be used at or by the second network node 702b.

At 712, the first network node 702a sends, to the second network node 702b, a data frame that includes a concatenation of a plurality of packets (e.g., the concatenated packet 632 of FIG. 6). The data frame may be associated with a first protocol stack layer (e.g., an SDAP layer and/or PDCP layer) served at or by the first network node 702a. The data frame may be addressed to the UE 704, for example, for communication via a wireless communication link between the second network node 702b and the UE 704. The data frame may be communicated via a midhaul link, such as a FI-user plane interface.

At 714, the second network node 702b sends, to the UE 704, signaling that includes at least a portion of the data frame, for example, in accordance with the concatenated packet parameter(s). The signaling may be or include downlink signaling, such as signaling transmitted via a PDSCH and/or a PDCCH. The signaling may carry a payload (e.g., the payload of a MAC PDU) that includes at least a portion of the data frame. In certain cases, the payload may include all of the data frame, for example, in a transport block, and thus, the second network node 702b may send the data frame without segmentation.

As an example, the second network node 702b may refrain from performing packet segmentation on the data frame based on the concatenated packet parameter(s) indicating to disable packet segmentation of a concatenated packet. As another example, the second network node 702b may allocate the grant size, associated with the signaling, to satisfy a minimum grant size indicated in the concatenated packet parameter(s). In certain cases, the size of the data frame may satisfy the minimum grant size (e.g., the size of the data frame may be less than or equal to the minimum grant size), such that the second network node 702b can communicate the data frame without packet segmentation (for example, pass the data frame through the protocol stack layer(s) served at or by the second network node without packet segmentation).

The concatenated packet parameter(s) may ensure the first network node 702b and the second network node 702b are aligned in terms how to communicate a concatenated packet through at least the protocol stack layer(s) served at or by the second network node 702b. Accordingly, the concatenated packet parameter(s) may enable reduced latencies, reduced processing resource usage, improved channel usage, and/or the like, for example, due to a reduction in or prevention of packet segmentation of a concatenated packet.

In certain cases, the first network node 702a may reconfigure the concatenated packet parameter(s) in association with certain UE mobility operations, such as a handover, cell change (e.g., a secondary cell change), or the like. As an example, before, after, or as part of an intra-DU handover for the communication link with the UE 704, the operations at 706, 708, and 710 may be performed. A UE mobility operation, which may trigger reconfiguration of the concatenated packet parameter(s), may include, for example, intra-DU handover, inter-DU-intra-CU handover, inter-CU handover, (conditional) lower-layer triggered mobility (LTM), layer-three (L3) mobility, an Xn based handover, an N2 based handover, conditional handover, beam selection, beam switch, (conditional) serving cell modification or change, (conditional) serving cell addition, (conditional) serving cell release, cell group modification, cell group addition, cell group release, dual active protocol stack (DAPS) handover, dual connectivity, and/or the like. A mobility operation or handover may be triggered, for example, due to various criteria being satisfied, such as radio conditions (e.g., in response to a measurement report), load balancing at a network node, and/or a specific service (e.g., certain QoS specification(s) for communications may be satisfied by the mobility operation).

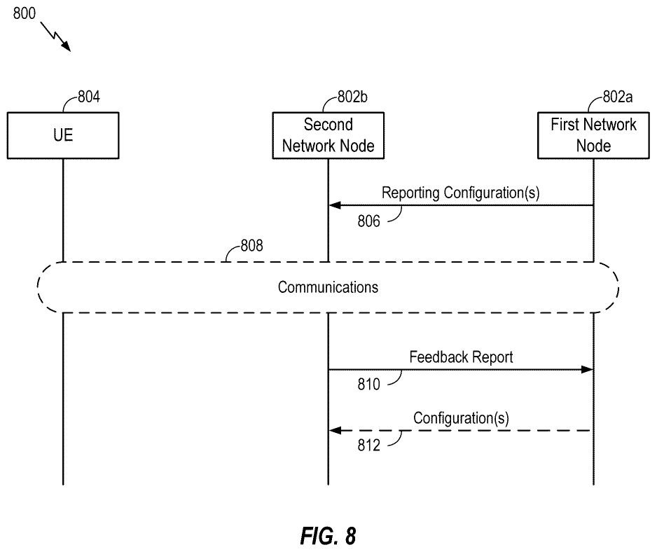

FIG. 8 depicts a process flow 800 for communication of feedback associated with packet concatenation in a system including a first network node 802a, a second network node 802b, and a UE 804.

In this example, a protocol stack may be split among the first network node 802a and the second network node 802b, for example, as described herein with respect to FIG. 6. The first network node 802a may be an example of the first network node 602a of FIG. 6; the second network node 802b may be an example of the second network node 602b of FIG. 6; and the UE 804 may be an example of the UE 604 of FIG. 6.

At 806, the first network node 802a sends, to the second network node 802b, one or more reporting configuration(s), which may include an indication to report feedback associated with communication of a concatenated packet through at least a portion of the protocol stack layer(s) served at or by the second network node 802b.

The indication to report feedback may indicate the information (e.g., the quantities) to include in a feedback report. As an example, the feedback may include recommendations for the concatenated packet parameter(s) and/or past performance data, for example, as described herein with respect to FIG. 6. The indication to report feedback may indicate to report the feedback periodically (e.g., with a periodicity). The indication to report feedback may indicate aperiodic reporting (e.g., to report the feedback aperiodically). The indication to report feedback may indicate certain criteria that trigger reporting feedback, for example, when a cell becomes congested (e.g., a threshold traffic load is reached), when the UE 804 moves outside or within a cell coverage area, or when the radio conditions change, etc. The indication to report feedback may indicate to report the feedback for every transmission or every Nth transmission, such as the expected grant size for a transmission. In certain aspects, the configuration(s) of FIG. 7 may include the reporting configuration(s) of FIG. 8.

At 808, the second network node 802b communicates with the UE 804, for example, as described herein with respect to FIGS. 6 and 7. For example, the first network node 802a may send one or more concatenated packets to the second network node 802b; and the second network node 802b may send downlink signaling, which carries the concatenated packet(s), to the UE 804.

At 810, the first network node 802a obtains, from the second network node 802b, a feedback report. In certain cases, the feedback report may include an indication of past performance information associated with downlink communications. In certain cases, the feedback report may include an indication of recommended values or settings for the concatenated packet parameter(s).

At 812, the first network node 802a optionally sends, to the second network node 802b, one or more configurations that indicate the concatenated packet parameter(s) based at least in part on the feedback report. As an example, the feedback report may indicate to change the minimum grant size, for example, due to a change in the MCS used for wireless communications with the UE 804. The first network node 802a may update the minimum grant size (for example, to satisfy the expected MCS) for communication of a concatenated packet.

The feedback may ensure the first network node 802a and the second network node 802b are aligned in terms how to communicate a concatenated packet through at least the protocol stack layer(s) served at or by the second network node 802b. For example, the feedback may enable the first network node 802a to configure the concatenated packet parameter(s), for example, in association with (e.g., in response to, before, or after) changes in radio conditions, traffic loads, etc. Accordingly, the feedback may enable reduced latencies, reduced processing resource usage, improved channel usage, and/or the like, for example, due to a reduction in or prevention of packet segmentation of a concatenated packet.

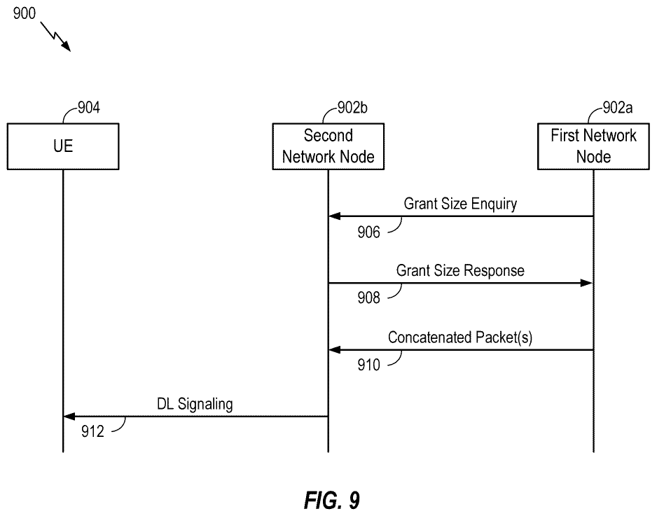

FIG. 9 depicts a process flow 900 for enquiry-response per packet in association with packet concatenation in a system including a first network node 902a, a second network node 902b, and a UE 904.

In this example, a protocol stack may be split among the first network node 902a and the second network node 902b, for example, as described herein with respect to FIG. 6. The first network node 902a may be an example of the first network node 602a of FIG. 6; the second network node 902b may be an example of the second network node 602b of FIG. 6; and the UE 904 may be an example of the UE 604 of FIG. 6.

At 906, the first network node 902a sends, to the second network node 902b, an enquiry message that requests an indication of a grant size for downlink communications with the UE 904 via a wireless communication link between the UE 904 and the second network node 902b. The indication of the grant size may indicate the maximum grant size, the minimum grant size,

The first network node 702a may send the enquiry message in association with processing one or more packets, which are addressed to the UE 904, such as the plurality of packets 630 of FIG. 6. As an example, before sending a concatenated packet to the second network node 902b, the first network node 902a may send the enquiry message to the second network node 902b to identify the current grant size available for downlink communications. In certain cases, the first network node 902a may send the enquiry message for every transmission (e.g., every PDU passed to the second network node 902b) or every Nth transmission (e.g., every Nth PDU).

At 908, the first network node 902a obtains, from the second network node 902b, a response message that indicates the grant size for downlink communications. The grant size may be a maximum grant size, a minimum grant size, an expected grant size, or a recommended grant size for downlink communications with the UE 904.

At 910, the first network node 902a sends, to the second network node 902b, a data frame that includes a concatenation of a plurality of packets (e.g., the concatenated packet 632 of FIG. 6). The data frame may have a size that satisfies the grant size indicated at 908. As an example, the first network node 902a may generate a PDU that has a size that satisfies the grant size indicated at 908. The first network node 902a may concatenate a plurality of packets into the data frame, such that the data frame has a size that satisfies the grant size indicated at 908. The PDU may have a size that enables encapsulation performed at the protocol stack layer(s) served at or by the second network node 902b to satisfy the grant size. The PDU may have a payload that includes a concatenation of packets, for example, as described herein with respect to FIG. 6.

In certain aspects, the operations at 906, 908, and 910 may be performed in real-time, for example, as packets arrive at the first network node 902a for transmission to the UE 904. The real-time enquiry and response may enable the first network node 902a to adapt to changes in the wireless communication link with the UE 904 (e.g., changes in the MCS, radio conditions, serving cell, carrier aggregation, dual connectivity, etc.). Accordingly, the enquiry-response messaging may enable reduced latencies, reduced processing resource usage, improved channel usage, and/or the like, for example, due to a reduction in or prevention of packet segmentation of a concatenated packet.

At 912, the second network node 902b sends, to the UE 904, signaling that includes at least a portion of the data frame, for example, in accordance with the grant size indicated at 908. The signaling may be or include downlink signaling, such as signaling transmitted via a PDSCH and/or a PDCCH.

Note that the process flows illustrated in FIGS. 7-9 are described herein to facilitate an understanding of communication of a concatenated packet through a disaggregated RAN, and aspects of the present disclosure may be performed in various manners via alternative or additional signaling and/or operations. In certain aspects, the operations and/or signaling of FIGS. 7-9 may occur in an order different from that described or depicted, and various actions, operations, and/or signaling may be added, omitted, or combined.

### Example Operations of Protocol Stack Concatenation Configuration

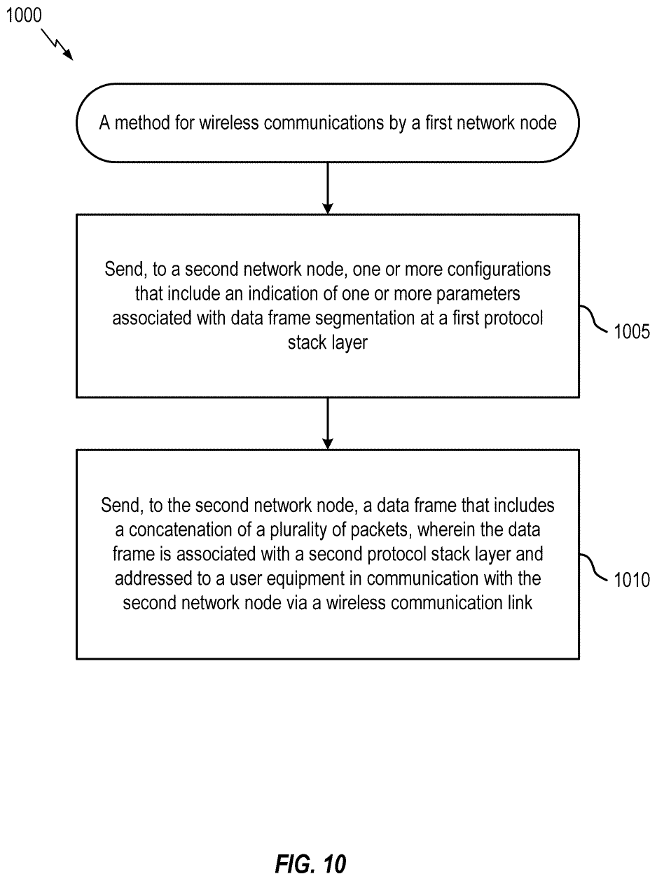

FIG. 10 shows a method 1000 for wireless communications by a first network node, such as BS 102 of FIG. 1, a first network entity 300 or second network entity 302 of FIG. 3, or a disaggregated base station as discussed with respect to FIG. 2. In certain aspects, the first network node may be an example of the CU 210 of FIG. 2 and/or the first network entity 300 of FIG. 3. The first network node may include a CU and/or a DU.

Method 1000 begins at block 1005 with sending, to a second network node, one or more configurations that include an indication of one or more parameters associated with data frame segmentation at a first protocol stack layer, for example, as described herein with respect to FIGS. 6-9. The second network node may be an example of the DU 230 of FIG. 2, the RU 240 of FIG. 2, and/or the second network entity 302 of FIG. 3. The second network node may include a DU and/or an RU. In certain aspects, the one or more parameters may be associated with communication of a concatenated packet through at least a portion of the protocol stack layers served at or by the second network node.

Method 1000 then proceeds to block 1010 with sending, to the second network node, a data frame that includes a concatenation of a plurality of packets, wherein the data frame is associated with a second protocol stack layer and addressed to a user equipment in communication with the second network node via a wireless communication link, for example, as described herein with respect to FIGS. 6-9.

In certain aspects, method 1000 further includes obtaining the plurality of packets.

In certain aspects, method 1000 further includes concatenating the plurality of packets into a payload included in the data frame at the second protocol stack layer.

In some aspects, the plurality of packets includes a plurality of internet protocol packets; the data frame includes a service data unit that includes the concatenation of the plurality of internet protocol packets; the second protocol stack layer includes a SDAP layer or a PDCP layer; and the first protocol stack layer includes a RLC layer or a MAC layer.

In some aspects, the one or more parameters comprise one or more of: a minimum grant size for downlink communications; an indication of whether segmentation of the data frame is enabled; an indication of whether segmentation of header information is enabled; a timer that indicates a time at which to activate (or enable) segmentation of the data frame; or a grant size scaling factor for downlink communications.

In certain aspects, method 1000 further includes obtaining, from the second network node, an indication of at least one parameter of the one or more parameters, wherein the one or more configurations are based at least in part on the indication of the at least one parameter. In some aspects, the at least one parameter of the one or more parameters comprises one or more of: a minimum grant size for downlink communications; a maximum grant size for downlink communications; a grant size scaling factor for downlink communications; a grant allocation periodicity; a maximum data frame size; or a minimum data frame size.

In certain aspects, method 1000 further includes obtaining, from the second network node, an indication of past performance information associated with downlink communications, wherein the one or more configurations are based at least in part on the past performance information. In some aspects, the past performance information comprises one or more of: an indication of a grant size allocated for downlink communications over a past time window; an indication of a segmentation rate associated with at least one data frame over the past time window; or an indication of a data frame size communicated over the past time window.

In certain aspects, method 1000 further includes sending, to the second network node, a request for capability information associated with segmentation of the data frame. In certain aspects, method 1000 further includes obtaining, from the second network node, the capability information, wherein the one or more configurations are based at least in part on the capability information. In some aspects, the capability information comprises one or more of: an indication of a maximum supported size for the data frame; or an indication of a data rate for downlink communications. In some aspects, sending the request comprises sending the request in association with a mobility operation (e.g., a UE mobility operation including a handover, cell release, cell addition, or a cell update).

In some aspects, the one or more configurations include an indication to report feedback associated with data frame segmentation; and the method 1000 further comprises obtaining, from the second network node, a feedback report that includes an indication of past performance information associated with downlink communications.

In some aspects, the indication to report feedback comprises: an indication to report the feedback periodically; an indication to report the feedback aperiodically; or an indication to report the feedback per downlink transmission.

In certain aspects, method 1000 further includes sending, to the second network node, a request for an indication of a grant size for downlink communications with the user equipment via the wireless communication link. In certain aspects, method 1000 further includes obtaining, from the second network node, the indication of the grant size, wherein the data frame satisfies the grant size.

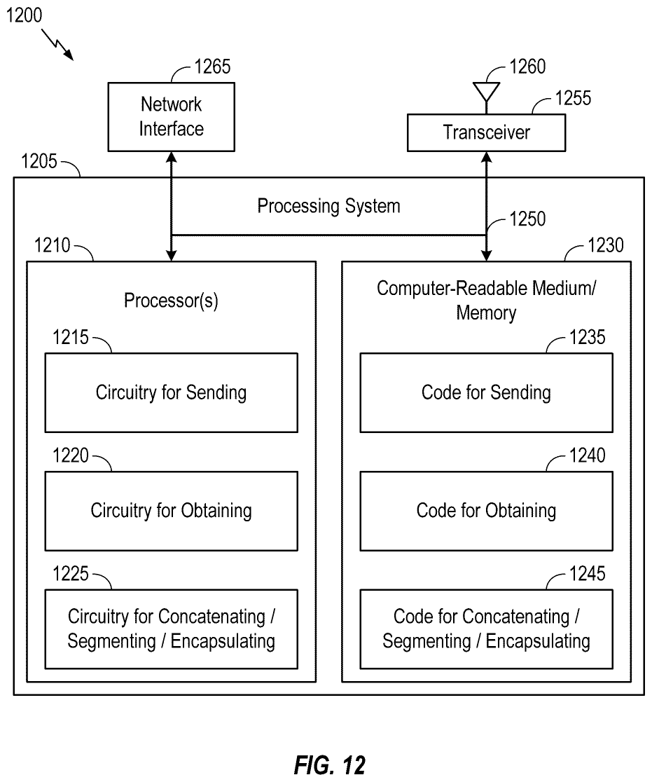

In some aspects, method 1000, or any aspect related to it, may be performed by an apparatus, such as communications device 1200 of FIG. 12, which includes various components operable, configured, or adapted to perform the method 1000. Communications device 1200 is described below in further detail.

Note that FIG. 10 is just one example of a method, and other methods including fewer, additional, or alternative operations are possible consistent with this disclosure.

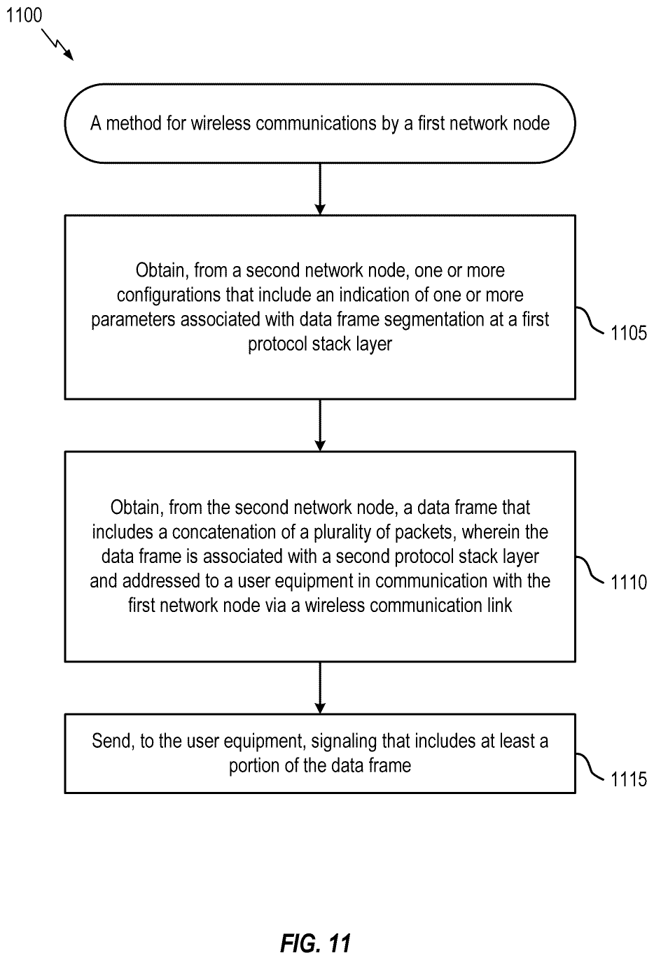

FIG. 11 shows a method 1100 for wireless communications by a first network node, such as BS 102 of FIG. 1, a first network entity 300 or second network entity 302 of FIG. 3, or a disaggregated base station as discussed with respect to FIG. 2. In certain aspects, the first network node may be an example of the DU 230 of FIG. 2, the RU 240 of FIG. 2, and/or the second network entity 302 of FIG. 3. The first network node may include a DU and/or an RU.

Method 1100 begins at block 1105 with obtaining, from a second network node, one or more configurations that include an indication of one or more parameters associated with data frame segmentation at a first protocol stack layer, for example, as described herein with respect to FIGS. 6-9. In certain aspects, the second network node may be an example of the CU 210 of FIG. 2 and/or the first network entity 300 of FIG. 3. The second network node may include a CU and/or a DU. In certain aspects, the one or more parameters may be associated with communication of a concatenated packet through at least a portion of the protocol stack layers served at or by the first network node.

Method 1100 then proceeds to block 1110 with obtaining, from the second network node, a data frame that includes a concatenation of a plurality of packets, wherein the data frame is associated with a second protocol stack layer and addressed to a user equipment in communication with the first network node via a wireless communication link, for example, as described herein with respect to FIGS. 6-9.

Method 1100 then proceeds to block 1115 with sending, to the user equipment, signaling that includes at least a portion of the data frame, for example, as described herein with respect to FIGS. 6-9.

In some aspects, the signaling includes the data frame, in a protocol data unit, without segmentation of the data frame.

In some aspects, the plurality of packets includes a plurality of internet protocol packets; the data frame includes a service data unit that includes the concatenation of the plurality of internet protocol packets; the second protocol stack layer includes a SDAP layer or a PDCP layer; and the first protocol stack layer includes a RLC layer or a MAC layer.

In some aspects, the one or more parameters comprise one or more of: a minimum grant size for downlink communications; an indication of whether segmentation of the data frame is enabled; an indication of whether segmentation of header information is enabled; a timer that indicates a time at which to activate (or enable) segmentation of the data frame; or a grant size scaling factor for downlink communications.

In certain aspects, method 1100 further includes sending, to the second network node, an indication of at least one parameter of the one or more parameters, wherein the one or more configurations are based at least in part on the indication of the at least one parameter. In some aspects, the at least one parameter of the one or more parameters comprises one or more of: a minimum grant size for downlink communications; a maximum grant size for downlink communications; a grant size scaling factor for downlink communications; a grant allocation periodicity; a maximum data frame size; or a minimum data frame size.

In certain aspects, method 1100 further includes sending, to the second network node, an indication of past performance information associated with downlink communications, wherein the one or more configurations are based at least in part on the past performance information. In some aspects, the past performance information comprises one or more of: an indication of a grant size allocated for downlink communications over a past time window; an indication of a segmentation rate associated with at least one data frame over the past time window; or an indication of a data frame size communicated over the past time window.

In certain aspects, method 1100 further includes obtaining, from the second network node, a request for capability information associated with segmentation of the data frame. In certain aspects, method 1100 further includes sending, to the second network node, the capability information, wherein the one or more configurations are based at least in part on the capability information. In some aspects, the capability information comprises one or more of: an indication of a maximum supported size for the data frame; or an indication of a data rate for downlink communications. In some aspects, obtaining the request comprises obtaining the request in association with a mobility operation.

In some aspects, the one or more configurations include an indication to report feedback associated with data frame segmentation; and the method 1100 further comprises sending, to the second network node, a feedback report that includes an indication of past performance information associated with downlink communications. In some aspects, the indication to report feedback comprises: an indication to report the feedback periodically; an indication to report the feedback aperiodically; or an indication to report the feedback per downlink transmission.

In certain aspects, method 1100 further includes obtaining, from the second network node, a request for an indication of a grant size for downlink communications with the user equipment via the wireless communication link. In certain aspects, method 1100 further includes sending, to the second network node, the indication of the grant size, wherein the data frame satisfies the grant size.

In some aspects, method 1100, or any aspect related to it, may be performed by an apparatus, such as communications device 1200 of FIG. 12, which includes various components operable, configured, or adapted to perform the method 1100. Communications device 1200 is described below in further detail.

Note that FIG. 11 is just one example of a method, and other methods including fewer, additional, or alternative operations are possible consistent with this disclosure.

### Example Communications Device

FIG. 12 depicts aspects of an example communications device configured for wireless communications. In some aspects, communications device 1200 is a network entity, such as BS 102 of FIG. 1, first network entity 300 or second network entity 302 of FIG. 3, or a disaggregated base station as discussed with respect to FIG. 2.

The communications device 1200 includes a processing system 1205 coupled to a transceiver 1255 (e.g., a transmitter and/or a receiver) and/or a network interface 1265. The transceiver 1255 is configured to transmit and receive signals for the communications device 1200 via an antenna 1260, such as the various signals as described herein. The network interface 1265 is configured to obtain and send signals for the communications device 1200 via communications link(s), such as a backhaul link, midhaul link, and/or fronthaul link as described herein, such as with respect to FIG. 2. The processing system 1205 may be configured to perform processing functions for the communications device 1200, including processing signals received and/or to be transmitted by the communications device 1200.

The processing system 1205 includes one or more processors 1210 and a computer-readable medium/memory 1230. In various aspects, one or more processors 1210 may be representative of the one or more processors 308, as described with respect to FIG. 3. The one or more processors 1210 are coupled to the computer-readable medium/memory 1230 via a bus 1250. In certain aspects, the computer-readable medium/memory 1230 is configured to store instructions (e.g., computer-executable code), including code 1235-1245, that when executed by the one or more processors 1210, cause the one or more processors 1210 to perform the method 1000 described with respect to FIG. 10, or any aspect related to it, including any operations described in relation to FIG. 10; and/or the method 1100 described with respect to FIG. 11, or any aspect related to it, including any operations described in relation to FIG. 11. The computer-readable medium/memory 1230 is a non-transitory computer-readable medium/memory. Note that reference to a processor of communications device 1200 performing a function may include one or more processors of communications device 1200 performing that function, such as in a distributed fashion.

In the depicted example, the computer-readable medium/memory 1230 stores code (e.g., executable instructions), including code for sending 1235, code for obtaining 1240, code for concatenating 1245, or any combination thereof. Processing of the code 1235-1245 may enable and cause the communications device 1200 to perform the method 1000 described with respect to FIG. 10, or any aspect related to it; and/or the method 1100 described with respect to FIG. 11, or any aspect related to it. For instance, in some aspects, code for sending 1235 includes code for sending, to a second network node, one or more configurations that include an indication of one or more parameters associated with data frame segmentation at a first protocol stack layer. In some aspects, code for sending 1235 includes code for sending, to the second network node, a data frame that includes a concatenation of a plurality of packets, wherein the data frame is associated with a second protocol stack layer and addressed to a user equipment in communication with the second network node via a wireless communication link.

For instance, in some aspects, code for obtaining 1240 includes code for obtaining, from a second network node, one or more configurations that include an indication of one or more parameters associated with data frame segmentation at a first protocol stack layer. In some aspects, code for obtaining 1240 includes code for obtaining, from the second network node, a data frame that includes a concatenation of a plurality of packets, wherein the data frame is associated with a second protocol stack layer and addressed to a user equipment in communication with the first network node via a wireless communication link. In some aspects, code for sending 1235 includes code for sending, to the user equipment, signaling that includes at least a portion of the data frame.

The one or more processors 1210 include circuitry configured to implement (e.g., execute) the code stored in the computer-readable medium/memory 1230, including circuitry for sending 1215, circuitry for obtaining 1220, circuitry for concatenating 1225, or any combination thereof. Processing with circuitry 1215-1225 may enable and cause the communications device 1200 to perform the method 1000 described with respect to FIG. 10, or any aspect related to it; and/or the method 1100 described with respect to FIG. 11, or any aspect related to it. For instance, in some aspects, circuitry for sending 1215 includes circuitry for sending, to a second network node, one or more configurations that include an indication of one or more parameters associated with data frame segmentation at a first protocol stack layer. In some aspects, circuitry for sending 1215 includes circuitry for sending, to the second network node, a data frame that includes a concatenation of a plurality of packets, wherein the data frame is associated with a second protocol stack layer and addressed to a user equipment in communication with the second network node via a wireless communication link.

For instance, in some aspects, circuitry for obtaining 1220 includes circuitry for obtaining, from a second network node, one or more configurations that include an indication of one or more parameters associated with data frame segmentation at a first protocol stack layer. In some aspects, circuitry for obtaining 1220 includes circuitry for obtaining, from the second network node, a data frame that includes a concatenation of a plurality of packets, wherein the data frame is associated with a second protocol stack layer and addressed to a user equipment in communication with the first network node via a wireless communication link. In some aspects, circuitry for sending 1215 includes circuitry for sending, to the user equipment, signaling that includes at least a portion of the data frame.

Various components of the communications device 1200 may provide means for performing the method 1000 described with respect to FIG. 10, or any aspect related to it; and/or the method 1100 described with respect to FIG. 11, or any aspect related to it. Means for communicating, transmitting, sending or outputting for transmission may include the one or more transceivers 312, one or more antennas 314, and/or processing system 306 of the first network entity 300 or the second network entity 302 illustrated in FIG. 3, transceiver 1255, antenna 1260, and/or network interface 1265 of the communications device 1200 in FIG. 12, and/or one or more processors 1210 of the communications device 1200 in FIG. 12. Means for communicating, receiving or obtaining may include the one or more transceivers 312, one or more antennas 314, and/or processing system 306 of the first network entity 300 or the second network entity 302 illustrated in FIG. 3, transceiver 1255, antenna 1260, and/or network interface 1265 of the communications device 1200 in FIG. 12, and/or one or more processors 1210 of the communications device 1200 in FIG. 12. For example, means for concatenating, means for segmenting, and/or means for encapsulating of the method 1000 described with respect to FIG. 10, or any aspect related to it; and/or the method 1100 described with respect to FIG. 11, or any aspect related to it, may include the processing system 306 of the first network entity 300 or the second network entity 302 illustrated in FIG. 3, and/or one or more processors 1210 of the communications device 1200 in FIG. 12.

### Example Clauses

Implementation examples are described in the following numbered clauses:

Clause 1: A method for wireless communications by a first network node comprising: sending, to a second network node, one or more configurations that include an indication of one or more parameters associated with data frame segmentation at a first protocol stack layer; and sending, to the second network node, a data frame that includes a concatenation of a plurality of packets, wherein the data frame is associated with a second protocol stack layer and addressed to a user equipment in communication with the second network node via a wireless communication link.

Clause 2: The method of Clause 1, further comprising: obtaining the plurality of packets; and concatenating the plurality of packets into a payload included in the data frame at the second protocol stack layer.

Clause 3: The method of Clause 2, wherein: the plurality of packets includes a plurality of internet protocol packets; the data frame includes a service data unit that includes the concatenation of the plurality of internet protocol packets; the second protocol stack layer includes a SDAP layer or a PDCP layer; and the first protocol stack layer includes a RLC layer or a MAC layer.

Clause 4: The method of any one of Clauses 1-3, wherein the one or more parameters comprise one or more of: a minimum grant size for downlink communications; an indication of whether segmentation of the data frame is enabled; an indication of whether segmentation of header information is enabled; a timer that indicates a time at which to activate segmentation of the data frame; or a grant size scaling factor for downlink communications.

Clause 5: The method of any one of Clauses 1-4, further comprising obtaining, from the second network node, an indication of at least one parameter of the one or more parameters, wherein the one or more configurations are based at least in part on the indication of the at least one parameter.

Clause 6: The method of Clause 5, wherein the at least one parameter of the one or more parameters comprises one or more of: a minimum grant size for downlink communications; a maximum grant size for downlink communications; a grant size scaling factor for downlink communications; a grant allocation periodicity; a maximum data frame size; or a minimum data frame size.

Clause 7: The method of any one of Clauses 1-6, further comprising obtaining, from the second network node, an indication of past performance information associated with downlink communications, wherein the one or more configurations are based at least in part on the past performance information.

Clause 8: The method of Clause 7, wherein the past performance information comprises one or more of: an indication of a grant size allocated for downlink communications over a past time window; an indication of a segmentation rate associated with at least one data frame over the past time window; or an indication of a data frame size communicated over the past time window.

Clause 9: The method of any one of Clauses 1-8, further comprising sending, to the second network node, a request for capability information associated with segmentation of the data frame; and obtaining, from the second network node, the capability information, wherein the one or more configurations are based at least in part on the capability information.

Clause 10: The method of Clause 9, wherein the capability information comprises one or more of: an indication of a maximum supported size for the data frame; or an indication of a data rate for downlink communications.

Clause 11: The method of Clause 9, wherein sending the request comprises sending the request in association with a mobility operation.

Clause 12: The method of any one of Clauses 1-11, wherein: the one or more configurations include an indication to report feedback associated with data frame segmentation; and the method further comprises obtaining, from the second network node, a feedback report that includes an indication of past performance information associated with downlink communications.

Clause 13: The method of Clause 12, wherein the indication to report feedback comprises: an indication to report the feedback periodically; an indication to report the feedback aperiodically; or an indication to report the feedback per downlink transmission.

Clause 14: The method of any one of Clauses 1-13, further comprising: sending, to the second network node, a request for an indication of a grant size for downlink communications with the user equipment via the wireless communication link; and obtaining, from the second network node, the indication of the grant size, wherein the data frame satisfies the grant size.

Clause 15: A method for wireless communications by a first network node comprising: obtaining, from a second network node, one or more configurations that include an indication of one or more parameters associated with data frame segmentation at a first protocol stack layer; obtaining, from the second network node, a data frame that includes a concatenation of a plurality of packets, wherein the data frame is associated with a second protocol stack layer and addressed to a user equipment in communication with the first network node via a wireless communication link; and sending, to the user equipment, signaling that includes at least a portion of the data frame.

Clause 16: The method of Clause 15, wherein the signaling includes the data frame, in a protocol data unit, without segmentation of the data frame.

Clause 17: The method of any one of Clauses 15-16, wherein: the plurality of packets includes a plurality of internet protocol packets; the data frame includes a service data unit that includes the concatenation of the plurality of internet protocol packets; the second protocol stack layer includes a SDAP layer or a PDCP layer; and the first protocol stack layer includes a RLC layer or a MAC layer.

Clause 18: The method of any one of Clauses 15-17, wherein the one or more parameters comprise one or more of: a minimum grant size for downlink communications; an indication of whether segmentation of the data frame is enabled; an indication of whether segmentation of header information is enabled; a timer that indicates a time at which to activate segmentation of the data frame; or a grant size scaling factor for downlink communications.

Clause 19: The method of any one of Clauses 15-18, further comprising: sending, to the second network node, an indication of at least one parameter of the one or more parameters, wherein the one or more configurations are based at least in part on the indication of the at least one parameter.

Clause 20: The method of Clause 19, wherein the at least one parameter of the one or more parameters comprises one or more of: a minimum grant size for downlink communications; a maximum grant size for downlink communications; a grant size scaling factor for downlink communications; a grant allocation periodicity; a maximum data frame size; or a minimum data frame size.

Clause 21: The method of any one of Clauses 15-20, further comprising: sending, to the second network node, an indication of past performance information associated with downlink communications, wherein the one or more configurations are based at least in part on the past performance information.

Clause 22: The method of Clause 21, wherein the past performance information comprises one or more of: an indication of a grant size allocated for downlink communications over a past time window; an indication of a segmentation rate associated with at least one data frame over the past time window; or an indication of a data frame size communicated over the past time window.

Clause 23: The method of any one of Clauses 15-22, further comprising: obtaining, from the second network node, a request for capability information associated with segmentation of the data frame; and sending, to the second network node, the capability information, wherein the one or more configurations are based at least in part on the capability information.

Clause 24: The method of Clause 23, wherein the capability information comprises one or more of: an indication of a maximum supported size for the data frame; or an indication of a data rate for downlink communications.

Clause 25: The method of Clause 23, wherein obtaining the request comprises obtaining the request in association with a mobility operation.

Clause 26: The method of any one of Clauses 15-25, wherein: the one or more configurations include an indication to report feedback associated with data frame segmentation; and the method further comprises sending, to the second network node, a feedback report that includes an indication of past performance information associated with downlink communications.

Clause 27: The method of Clause 26, wherein the indication to report feedback comprises: an indication to report the feedback periodically; an indication to report the feedback aperiodically; or an indication to report the feedback per downlink transmission.

Clause 28: The method of any one of Clauses 15-27, further comprising: obtaining, from the second network node, a request for an indication of a grant size for downlink communications with the user equipment via the wireless communication link; and sending, to the second network node, the indication of the grant size, wherein the data frame satisfies the grant size.

Clause 29: One or more apparatuses, comprising: one or more memories comprising executable instructions; and one or more processors configured to execute the executable instructions and cause the one or more apparatuses to perform a method in accordance with any one of Clauses 1-28.

Clause 30: One or more apparatuses configured for wireless communications, comprising: one or more memories; and one or more processors, coupled to the one or more memories, configured to cause the one or more apparatuses to perform a method in accordance with any one of Clauses 1-28.

Clause 31: One or more apparatuses configured for wireless communications, comprising: one or more memories; and one or more processors, coupled to the one or more memories, configured to perform a method in accordance with any one of Clauses 1-28.

Clause 32: One or more apparatuses, comprising means for performing a method in accordance with any one of Clauses 1-28.

Clause 33: One or more non-transitory computer-readable media comprising executable instructions that, when executed by one or more processors of one or more apparatuses, cause the one or more apparatuses to perform a method in accordance with any one of Clauses 1-28.

Clause 34: One or more computer program products embodied on one or more computer-readable storage media comprising code for performing a method in accordance with any one of Clauses 1-28.

Clause 35: One or more apparatuses configured for wireless communications, comprising: a processing system that includes one or more processors and one or more memories coupled with the one or more processors, the processing system configured to cause the one or more apparatuses to perform a method in accordance with any one of Clauses 1-28.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, an AI processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a SoC, a SiP, or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, “coupled to” and “coupled with” generally encompass direct coupling and indirect coupling (e.g., including intermediary coupled aspects) unless stated otherwise. For example, stating that a processor is coupled to a memory allows for a direct coupling or a coupling via an intermediary aspect, such as a bus.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an ASIC, or processor.

The following claims are not intended to be limited to the aspects shown herein, but are to be accorded the full scope consistent with the language of the claims. Reference to an element in the singular is not intended to mean only one unless specifically so stated, but rather “one or more.” The subsequent use of a definite article (e.g., “the” or “said”) with an element (e.g., “the processor”) is not intended to invoke a singular meaning (e.g., “only one”) on the element unless otherwise specifically stated. For example, reference to an element (e.g., “a processor,” “the processor,” etc.), unless otherwise specifically stated, should be understood to refer to one or more elements (e.g., “one or more processors,” or the like). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more. All structural and functional equivalents to the elements of the various aspects described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims.

What is claimed is:

1. An apparatus for wireless communications, comprising a processing system that includes one or more processors and one or more memories coupled with the one or more processors, the processing system configured to cause a first network node to:
send, to a second network node, one or more configurations that include an indication of one or more parameters associated with data frame segmentation at a first protocol stack layer; and
send, to the second network node, a data frame that includes a concatenation of a plurality of packets, wherein the data frame is associated with a second protocol stack layer and addressed to a user equipment in communication with the second network node via a wireless communication link.

2. The apparatus of claim 1, wherein the processing system is configured to cause the first network node to:
obtain the plurality of packets; and
concatenate the plurality of packets into a payload included in the data frame at the second protocol stack layer.

3. The apparatus of claim 2, wherein:
the plurality of packets includes a plurality of internet protocol packets;
the data frame includes a service data unit that includes the concatenation of the plurality of internet protocol packets;
the second protocol stack layer includes a service data adaptation protocol (SDAP) layer or a packet data convergence protocol (PDCP) layer; and
the first protocol stack layer includes a radio link control (RLC) layer or a medium access control (MAC) layer.

4. The apparatus of claim 1, wherein the one or more parameters comprise one or more of:
a minimum grant size for downlink communications;
an indication of whether segmentation of the data frame is enabled;
an indication of whether segmentation of header information is enabled;
a timer that indicates a time at which to activate segmentation of the data frame; or
a grant size scaling factor for downlink communications.

5. The apparatus of claim 1, wherein the processing system is configured to cause the first network node to obtain, from the second network node, an indication of at least one parameter of the one or more parameters, wherein the one or more configurations are based at least in part on the indication of the at least one parameter.

6. The apparatus of claim 5, wherein the at least one parameter of the one or more parameters comprises one or more of:
a minimum grant size for downlink communications;
a maximum grant size for downlink communications;
a grant size scaling factor for downlink communications;
a grant allocation periodicity;
a maximum data frame size; or
a minimum data frame size.

7. The apparatus of claim 1, wherein the processing system is configured to cause the first network node to obtain, from the second network node, an indication of past performance information associated with downlink communications, wherein the one or more configurations are based at least in part on the past performance information.

8. The apparatus of claim 7, wherein the past performance information comprises one or more of:
an indication of a grant size allocated for downlink communications over a past time window;
an indication of a segmentation rate associated with at least one data frame over the past time window; or
an indication of a data frame size communicated over the past time window.

9. The apparatus of claim 1, wherein the processing system is configured to cause the first network node to:
send, to the second network node, a request for capability information associated with segmentation of the data frame; and
obtain, from the second network node, the capability information, wherein the one or more configurations are based at least in part on the capability information.

10. The apparatus of claim 9, wherein the capability information comprises one or more of:
an indication of a maximum supported size for the data frame; or
an indication of a data rate for downlink communications.

11. The apparatus of claim 9, wherein to cause the first network node to send the request, the processing system is configured to cause the first network node to send the request in association with a mobility operation.

12. The apparatus of claim 1, wherein:
the one or more configurations include an indication to report feedback associated with data frame segmentation; and
the processing system is configured to cause the first network node to obtain, from the second network node, a feedback report that includes an indication of past performance information associated with downlink communications.

13. The apparatus of claim 12, wherein the indication to report feedback comprises:
an indication to report the feedback periodically;
an indication to report the feedback aperiodically; or
an indication to report the feedback per downlink transmission.

14. The apparatus of claim 1, wherein the processing system is configured to cause the first network node to:
send, to the second network node, a request for an indication of a grant size for downlink communications with the user equipment via the wireless communication link; and
obtain, from the second network node, the indication of the grant size, wherein the data frame satisfies the grant size.

15. An apparatus for wireless communications, comprising a processing system that includes one or more processors and one or more memories coupled with the one or more processors, the processing system configured to cause a first network node to:
obtain, from a second network node, one or more configurations that include an indication of one or more parameters associated with data frame segmentation at a first protocol stack layer;
obtain, from the second network node, a data frame that includes a concatenation of a plurality of packets, wherein the data frame is associated with a second protocol stack layer and addressed to a user equipment in communication with the first network node via a wireless communication link; and
send, to the user equipment, signaling that includes at least a portion of the data frame.

16. The apparatus of claim 15, wherein the signaling includes the data frame, in a protocol data unit, without segmentation of the data frame.

17. The apparatus of claim 15, wherein:
the plurality of packets includes a plurality of internet protocol packets;
the data frame includes a service data unit that includes the concatenation of the plurality of internet protocol packets;
the second protocol stack layer includes a service data adaptation protocol (SDAP) layer or a packet data convergence protocol (PDCP) layer; and
the first protocol stack layer includes a radio link control (RLC) layer or a medium access control (MAC) layer.

18. The apparatus of claim 15, wherein the one or more parameters comprise one or more of:
a minimum grant size for downlink communications;
an indication of whether segmentation of the data frame is enabled;
an indication of whether segmentation of header information is enabled;
a timer that indicates a time at which to active segmentation of the data frame; or
a grant size scaling factor for downlink communications.

19. The apparatus of claim 15, wherein the processing system is configured to cause the first network node to send, to the second network node, an indication of at least one parameter of the one or more parameters, wherein the one or more configurations are based at least in part on the indication of the at least one parameter.

20. A method for wireless communications by a first network node, comprising:
sending, to a second network node, one or more configurations that include an indication of one or more parameters associated with data frame segmentation at a first protocol stack layer; and
sending, to the second network node, a data frame that includes a concatenation of a plurality of packets, wherein the data frame is associated with a second protocol stack layer and addressed to a user equipment in communication with the second network node via a wireless communication link.
